(19) United States
(12) Patent Application Publication
(10) Pub. No.: US 2026/0362534 A1
(43) Pub. Date: Nov. 12, 2026

(54) COMMUNICATION METHOD AND APPARATUS, USER EQUIPMENT, BASE STATION, AND STORAGE MEDIUM

(71) Applicant: VIVO MOBILE COMMUNICATION CO., LTD., Dongguan (CN)

(72) Inventor: Hongping ZHANG, Dongguan (CN)

(73) Assignee: VIVO MOBILE COMMUNICATION CO., LTD., Dongguan (CN)

(21) Appl. No.: 19/740,045

(22) Filed: Jul. 13, 2026

Related U.S. Application Data
(63) Continuation of application No. PCT/CN2025/071569, filed on Jan. 9, 2025.

(30) Foreign Application Priority Data
Jan. 12, 2024 (CN) 202410052512.6

(51) Int. Cl. H04W 76/19; H04L 9/08; H04L 69/322

(52) U.S. Cl. CPC H04W 76/19; H04L 9/0822; H04L 69/322

(57) ABSTRACT

A communication method and apparatus, user equipment, a base station, and a storage medium, are provided. The method includes: sending, by User Equipment (UE), a Radio Resource Control (RRC) reestablishment request message to a base station; and receiving, by a Medium Access Control (MAC) layer of the UE, a first Medium Access Control Control Element (MAC CE) from the base station, where the first MAC CE includes a Next hop Chaining Count (NCC) and a first byte stream, the first byte stream includes an encrypted RRC reestablishment message, and the RRC reestablishment message is used to instruct the UE to reestablish an RRC connection.

### CROSS-REFERENCE TO RELATED APPLICATIONS

This application is a continuation of International Application No. PCT/CN2025/071569, filed Jan. 9, 2025, which claims priority to Chinese Patent No. 202410052512.6, filed Jan. 12, 2024. The entire contents of each of the above-referenced applications are expressly incorporated herein by reference.

### TECHNICAL FIELD

This application pertains to the field of communication technologies, and specifically relates to a communication method and apparatus, user equipment, a base station, and a storage medium.

### BACKGROUND

Currently, User Equipment (UE) and a base station update used keys in a Radio Resource Control (RRC) reestablishment process. Specifically, on the UE side, the UE may receive an RRC reestablishment message sent by the base station, where the RRC reestablishment message carries a Next hop Chaining Count (NextHop Chaining Count, NCC), and the UE may update, based on the NCC carried in the RRC reestablishment message, a key used by the UE. Because the UE needs to use the NCC to update the key, the RRC reestablishment message sent by the base station cannot be encrypted. If the RRC reestablishment message is encrypted, the UE cannot obtain the NCC, and therefore the used key cannot be updated. Consequently, security of the RRC reestablishment message is relatively low. Therefore, how to improve security of the RRC reestablishment message is an urgent problem to be resolved in this application.

### SUMMARY

Embodiments of this application provide a communication method and apparatus, user equipment, a base station, and a storage medium.

According to a first aspect, a communication method is provided, and the method includes: sending, by UE, an RRC reestablishment request message to a base station; and receiving, by a Medium Access Control (MAC) layer of the UE, a first Medium Access Control Control Element (MAC CE) from the base station, where the first MAC CE includes a n NCC and a first byte stream, the first byte stream includes an encrypted RRC reestablishment message, and the RRC reestablishment message is used to instruct the UE to reestablish an RRC connection.

According to a second aspect, a communication method is provided, and the method includes: receiving, by a base station, an RRC reestablishment request message from UE; and sending, by a MAC layer of the base station, a first MAC CE to the UE, where the first MAC CE includes an NCC and a first byte stream, the first byte stream includes an encrypted RRC reestablishment message, and the RRC reestablishment message is used to instruct the UE to reestablish an RRC connection.

According to a third aspect, a communication method is provided, and the method includes: sending, by UE, an RRC reestablishment request message to a base station; receiving, by the UE, first signaling from the base station, where the first signaling is used to request the UE to update a key used by the UE, the first signaling includes an NCC, and the first signaling is a second MAC CE or a PDCP control PDU; updating, by an RRC layer of the UE based on the NCC, the key used by the UE, and generating a first encryption key and a first integrity protection key based on the updated key; instructing, by the RRC layer of the UE, a Packet Data Convergence Protocol (PDCP) layer of the UE to resume integrity protection and encryption by using the first encryption key and the first integrity protection key; and after the PDCP layer of the UE resumes integrity protection and encryption by using the first encryption key and the first integrity protection key, processing, by the PDCP layer of the UE, a second PDCP Protocol Data Unit (PDU) from the base station, where the second PDCP PDU includes an RRC reestablishment message on which integrity protection and encryption have been performed, and the RRC reestablishment message is used to instruct the UE to reestablish an RRC connection.

According to a fourth aspect, a communication method is provided, and the method includes: receiving, by a base station, an RRC reestablishment request message from UE; sending, by the base station, first signaling to the UE, where the first signaling is used to request the UE to update a key used by the UE, the first signaling includes an NCC, and the first signaling is a second MAC CE or a PDCP control PDU; and sending, by the base station, a second PDCP PDU to the UE, where the second PDCP PDU includes an RRC reestablishment message on which integrity protection and encryption have been performed, and the RRC reestablishment message is used to instruct the UE to reestablish an RRC connection.

According to a fifth aspect, a communication apparatus is provided and is applied to UE. The apparatus includes a sending module and a receiving module. The sending module is configured to send an RRC reestablishment request message to a base station. The receiving module is configured to receive a first MAC CE from the base station, where the first MAC CE includes an NCC and a first byte stream, the first byte stream includes an encrypted RRC reestablishment message, and the RRC reestablishment message is used to instruct the UE to reestablish an RRC connection.

According to a sixth aspect, a communication apparatus is provided and is applied to a base station. The apparatus includes a receiving module and a sending module. The receiving module is configured to receive an RRC reestablishment request message from UE. The sending module is configured to send a first MAC CE to the UE, where the first MAC CE includes an NCC and a first byte stream, the first byte stream includes an encrypted RRC reestablishment message, and the RRC reestablishment message is used to instruct the UE to reestablish an RRC connection.

According to a seventh aspect, a communication apparatus is provided, and is applied to UE. The apparatus includes a sending module, a receiving module, a processing module, and an instructing module. The sending module is configured to send an RRC reestablishment request message to a base station. The receiving module is configured to receive first signaling from the base station, where the first signaling is used to request the UE to update a key used by the UE, the first signaling includes an NCC, and the first signaling is a second MAC CE or a PDCP control PDU. The processing module is configured to: update, based on the NCC, the key used by the UE, and generate a first encryption key and a first integrity protection key based on the updated key. The instructing module is configured to instruct a PDCP layer of the UE to resume integrity protection and encryption by using the first encryption key and the first integrity protection key that are generated by the processing module. The processing module is further configured to: after the PDCP layer of the UE resumes integrity protection and encryption by using the first encryption key and the first integrity protection key, process a second PDCP PDU from the base station, where the second PDCP PDU includes an RRC reestablishment message on which integrity protection and encryption have been performed, and the RRC reestablishment message is used to instruct the UE to reestablish an RRC connection.

According to an eighth aspect, a communication apparatus is provided, and the apparatus includes a receiving module and a sending module. The receiving module is configured to receive an RRC reestablishment request message from UE. The sending module is configured to: send first signaling to the UE, where the first signaling is used to request the UE to update a key used by the UE, the first signaling includes an NCC, and the first signaling is a second MAC CE or a PDCP control PDU; and send a second PDCP PDU to the UE, where the second PDCP PDU includes an RRC reestablishment message on which integrity protection and encryption have been performed, and the RRC reestablishment message is used to instruct the UE to reestablish an RRC connection.

According to a ninth aspect, UE is provided, and the UE includes a processor and a memory. The memory stores a program or an instruction that can be run on the processor, and the program or the instruction is executed by the processor to implement the steps of the method according to the first aspect.

According to a tenth aspect, UE is provided, including a processor and a communication interface. The communication interface is configured to: send an RRC reestablishment request message to a base station; and receive a first MAC CE from the base station, where the first MAC CE includes an NCC and a first byte stream, the first byte stream includes an encrypted RRC reestablishment message, and the RRC reestablishment message is used to instruct the UE to reestablish an RRC connection.

According to an eleventh aspect, a base station is provided, and the base station includes a processor and a memory, the memory stores a program or an instruction that can be run on the processor, and the program or the instruction is executed by the processor to implement the steps of the method according to the second aspect.

According to a twelfth aspect, a base station is provided, including a processor and a communication interface. The communication interface is configured to: receive an RRC reestablishment request message from UE; and send a first MAC CE to the UE, where the first MAC CE includes an NCC and a first byte stream, the first byte stream includes an encrypted RRC reestablishment message, and the RRC reestablishment message is used to instruct the UE to reestablish an RRC connection.

According to a thirteenth aspect, UE is provided, and the UE includes a processor and a memory. The memory stores a program or an instruction that can be run on the processor, and the program or the instruction is executed by the processor to implement the steps of the method according to the third aspect.

According to a fourteenth aspect, UE is provided, including a processor and a communication interface. The communication interface is configured to: send an RRC reestablishment request message to a base station; and receive first signaling from the base station, where the first signaling is used to request the UE to update a key used by the UE, the first signaling includes an NCC, and the first signaling is a second MAC CE or a PDCP control PDU. The processor is configured to: update, based on the NCC, the key used by the UE, and generate a first encryption key and a first integrity protection key based on the updated key; instruct a PDCP layer of the UE to resume integrity protection and encryption by using the first encryption key and the first integrity protection key; and after the PDCP layer of the UE resumes integrity protection and encryption by using the first encryption key and the first integrity protection key, process a second PDCP PDU from the base station, where the second PDCP PDU includes an RRC reestablishment message on which integrity protection and encryption have been performed, and the RRC reestablishment message is used to instruct the UE to reestablish an RRC connection.

According to a fifteenth aspect, a base station is provided, and the base station includes a processor and a memory. The memory stores a program or an instruction that can be run on the processor, and the program or the instruction is executed by the processor to implement the steps of the method according to the fourth aspect.

According to a sixteenth aspect, a base station is provided, including a processor and a communication interface. The communication interface is configured to receive an RRC reestablishment request message from UE; send first signaling to the UE, where the first signaling is used to request the UE to update a key used by the UE, the first signaling includes an NCC, and the first signaling is a second MAC CE or a PDCP control PDU; and send a second PDCP PDU to the UE, where the second PDCP PDU includes an RRC reestablishment message on which integrity protection and encryption have been performed, and the RRC reestablishment message is used to instruct the UE to reestablish the RRC connection.

According to a seventeenth aspect, a readable storage medium is provided. A program or an instruction is stored in the readable storage medium, and the program or the instruction is executed by a processor to implement the steps of the method according to the first aspect, or the steps of the method according to the second aspect, or the steps of the method according to the third aspect, or the steps of the method according to the fourth aspect.

According to an eighteenth aspect, a wireless communication system is provided, including: UE and a base station. The UE may be configured to perform the steps of the method according to the first aspect or the steps of the method according to the third aspect, and the base station may be configured to perform the steps of the method according to the second aspect or the steps of the method according to the fourth aspect.

According to a nineteenth aspect, a chip is provided. The chip includes a processor and a communication interface, the communication interface is coupled to the processor, and the processor is configured to run a program or an instruction to implement the method according to the first aspect, or the method according to the second aspect, or the method according to the third aspect, or the method according to the fourth aspect.

According to a twentieth aspect, a computer program/program product is provided. The computer program/program product is stored in a storage medium, and the program/program product is executed by at least one processor to implement the steps of the communication method according to the first aspect, or the steps of the communication method according to the second aspect, or the steps of the communication method according to the third aspect, or the steps of the communication method according to the fourth aspect.

In the embodiments of this application, UE sends an RRC reestablishment request message to a base station; and a MAC layer of the UE receives a first MAC CE from the base station, where the first MAC CE includes an NCC and a first byte stream, the first byte stream includes an encrypted RRC reestablishment message, and the RRC reestablishment message is used to instruct the UE to reestablish an RRC connection.

### BRIEF DESCRIPTION OF DRAWINGS

FIG. 1 is a schematic architecture diagram of a wireless communication system according to an embodiment of this application;

FIG. 2 is a first schematic flowchart of a communication method according to an embodiment of this application;

FIG. 3 is a second schematic flowchart of a communication method according to an embodiment of this application;

FIG. 4 is a first schematic structural diagram of a first MAC CE according to an embodiment of this application;

FIG. 5 is a schematic structural diagram of a first PDCP PDU according to an embodiment of this application;

FIG. 6 is a second schematic structural diagram of a first MAC CE according to an embodiment of this application;

FIG. 7 is a third schematic flowchart of a communication method according to an embodiment of this application;

FIG. 8 is a first schematic structural diagram of a communication apparatus according to an embodiment of this application;

FIG. 9 is a second schematic structural diagram of a communication apparatus according to an embodiment of this application;

FIG. 10 is a fourth schematic flowchart of a communication method according to an embodiment of this application;

FIG. 11 is a fifth schematic flowchart of a communication method according to an embodiment of this application;

FIG. 12 is a schematic structural diagram of a PDCP control PDU according to an embodiment of this application;

FIG. 13 is a sixth schematic flowchart of a communication method according to an embodiment of this application;

FIG. 14 is a seventh schematic flowchart of a communication method according to an embodiment of this application;

FIG. 15 is a third schematic structural diagram of a communication apparatus according to an embodiment of this application;

FIG. 16 is a fourth schematic structural diagram of a communication apparatus according to an embodiment of this application;

FIG. 17 is a schematic structural diagram of hardware of a communication device according to an embodiment of this application;

FIG. 18 is a schematic structural diagram of hardware of UE according to an embodiment of this application; and

FIG. 19 is a schematic structural diagram of hardware of a base station according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this application, the terms “first,” “second,” and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, “or” in this application means at least one of connected objects. For example, “A or B” covers three schemes. Scheme 1: including A but excluding B; Scheme 2: including B but excluding A; Scheme 3: including both A and B. The character “/” generally indicates an “or” relationship between the associated objects.

The term “indication” in this application may be either a direct indication (or an explicit indication) or an indirect indication (or an implicit indication). A direct indication may be understood as that a sender explicitly informs a recipient of content such as specific information, an operation to be performed, or a requested result in a sent indication. An indirect indication may be understood as that a recipient determines corresponding information based on an indication sent by a sender, or makes a judgment and determines an operation to be performed or a requested result based on a judgment result.

The term “at least one (item)” or “at least one of” in this application means any one of included objects, or any combination of two or more of included objects. For example, at least one of a, b, and c may represent “a,” “b,” “c,” “a and b,” “a and c,” “b and c,” and “a, b, and c,” where a, b, and c may be a single one or a plurality of. Similarly, “at least two (items)” refers to two or more, and its meaning is analogous to that of “at least one (item)”.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to systems other than the NR system, such as a 6th Generation (6G) communication system.

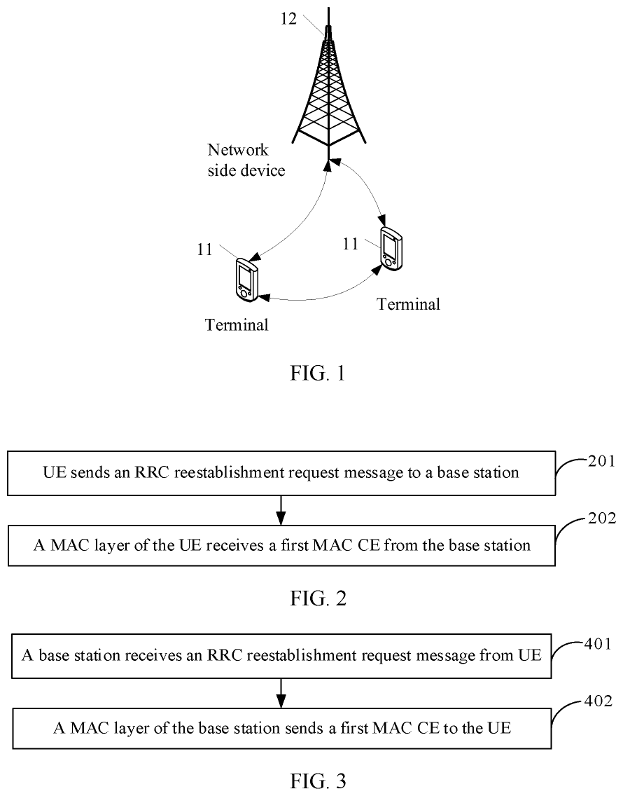

FIG. 1 is a block diagram of a wireless communication system to which the embodiments of this application can be applied. The wireless communication system includes a terminal 11 and a network side device 12. The terminal 11 may be a terminal side device such as User Equipment (UE), a mobile phone, a Tablet Personal Computer (Tablet PC), a Laptop Computer, a notebook computer, a Personal Digital Assistant (PDA), a palmtop computer, a netbook, an Ultra-Mobile Personal Computer (UMPC), a Mobile Internet Device (MID), an Augmented Reality (AR) device, a Virtual Reality (VR) device, a robot, a Wearable Device, a flight vehicle, Vehicle User Equipment (VUE), shipborne equipment, Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. The vehicle user equipment may also be referred to as an in-vehicle terminal, an in-vehicle controller, an in-vehicle module, an in-vehicle component, an in-vehicle chip, or an in-vehicle unit. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, or the like. The base station may be referred to as a NodeB (NB), an Evolved NodeB (eNB), a Next Generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a home evolved NodeB, a Transmission Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

The following describes some concepts and/or terms in the communication method provided in the embodiments of this application.
1. RRC reestablishment: In a case that UE is in an RRC connected state but the UE has a radio link failure or an integrity check failure, the UE may execute a cell selection process to select a target cell to initiate an RRC reestablishment process, and send an RRC Reestablishment Request to a base station in which the target cell is located via an SRB0.
2. Radio interface control plane protocol stack: The radio interface control plane protocol stack includes an RRC layer, a PDCP layer, an RLC layer, a MAC layer, and a PHY layer successively from top to bottom.
3. Protocol Data Units (PDUs) at a PDCP layer are classified into two types: a Data PDU and a Control PDU. The Data PDU is used to transmit data of a user plane and a control plane and a digital signature MAC-I generated through integrity protection, and the Control PDU is generated by the PDCP layer and is used to transmit, for example, a PDCP status report and a decompression feedback packet generated by a compression/decompression module. A data packet received by the PDCP layer from an upper layer is referred to as a PDCP Service Data Unit (SDU). After processing the PDCP SDU, the PDCP layer generates a PDCP Data PDU, and then delivers the PDCP Data PDU to a next layer for processing.

With reference to the accompanying drawings, the following describes in detail the communication method provided in the embodiments of this application by using some embodiments and application scenarios thereof.

Currently, UE and a base station update used keys in an RRC reestablishment process. Specifically, on the UE side, the UE may receive an RRC reestablishment message sent by the base station, where the RRC reestablishment message carries an NCC, and the UE may update, based on the NCC carried in the RRC reestablishment message, a key used by the UE. Because the UE needs to use the NCC to update the key, the RRC reestablishment message sent by the base station cannot be encrypted. If the RRC reestablishment message is encrypted, the UE cannot obtain the NCC, and therefore the used key cannot be updated. Specifically, on the base station side, if an NCC corresponding to a current key is the same as an NCC stored in a UE context of the UE, the key is updated based on the current key; otherwise, the key is updated based on a next hop (Next Hop, NH) corresponding to the NCC stored in the UE context of the UE, an encryption key and an integrity protection key are generated based on the updated key, and a PDCP layer is configured to resume integrity protection by using the new integrity protection key. The NCC stored in the UE context and the NH corresponding to the NCC may be sent by a core network to the base station in a previous handover process, and an RRC layer generates an RRC message RRC Reestablishment. The RRC Reestablishment message carries the NCC, and is delivered to a PDCP entity corresponding to an SRB1 as a PDCP SDU. The PDCP entity performs integrity protection by using the new integrity protection key, but does not perform an encryption operation; and then generates the PDCP PDU, and delivers the generated PDCP PDU to a Radio Link Control (RLC) layer to be sent to the UE. It can be learned that integrity protection has been performed on the RRC Reestablishment message but the message is not encrypted. Further, the base station configures the PDCP layer to resume encryption by using the new encryption key. On the UE side, after receiving the RRC Reestablishment message, the UE updates the key based on the NCC carried in the message, to generate the new encryption key and the integrity protection key, and then requests the PDCP layer to verify the message based on the new integrity protection key. If the verification succeeds, the PDCP layer is configured to resume integrity protection and encryption by using the new integrity protection key and the encryption key. It can be learned that because the UE needs to use the NCC to update the key, o nly integrity protection can be performed on the RRC Reestablishment message but the message cannot be encrypted. Otherwise, the UE cannot decrypt the RRC Reestablishment, and cannot obtain the NCC, and therefore the key cannot be updated. In this case, security of the RRC reestablishment message is relatively low. Therefore, how to improve security of the RRC reestablishment message is an urgent problem to be resolved in this application.

In the embodiments of this application, after the UE sends an RRC reestablishment request message to the base station, the base station may send a first MAC CE including an NCC and a first byte stream to the UE, where the first byte stream includes an encrypted RRC reestablishment message, that is, the base station may carry the NCC outside the encrypted RRC reestablishment message. Therefore, security of the RRC reestablishment message is improved while the UE obtains the NCC to update a key.

An embodiment of this application provides a communication method. FIG. 2 is a flowchart of a communication method according to an embodiment of this application. As shown in FIG. 2, the communication method provided in this embodiment of this application may include the following step 201 and step 202.

Step 201: UE sends an RRC reestablishment request message to a base station.

In some embodiments of this application, in a case that the UE is in an RRC connected state but an RRC connection needs to be reestablished, for example, the UE in the connected state has a radio link failure or an integrity check failure, the UE may execute a cell selection process to select a target cell to initiate an RRC reestablishment process, and send an RRC Reestablishment Request, that is, an RRC reestablishment request message, to the base station in which the target cell is located via an SRB0.

Step 202: A MAC layer of the UE receives a first MAC CE from the base station.

In this embodiment of this application, the first MAC CE includes an NCC and a first byte stream, the first byte stream includes an encrypted RRC reestablishment message, and the RRC reestablishment message is used to instruct the UE to reestablish an RRC connection.

In some embodiments of this application, the NCC is used to instruct the UE how update a key used by the UE. For details, refer to FIG. 6.9.2.1.1-1 in the 3GPP TS33.501 protocol. If an NCC corresponding to a current key (that is, a KgNB in the figure) is the same as the foregoing received NCC, a new key is generated based on the current key, that is, a horizontal derivation in the figure. If an NCC corresponding to a current key is different from the foregoing received NCC, a new key is generated based on an NH corresponding to the foregoing received NCC, that is, a vertical derivation in the figure. Further, the UE generates a first encryption key and a first integrity protection key based on the updated key.

In some embodiments of this application, the UE may resume integrity protection and encryption by using the first encryption key and the first integrity protection key.

It can be understood that, the base station may send the first MAC CE to the UE afte receiving the RRC reestablishment request sent by the UE, so that the UE can update, based on the NCC in the first MAC CE, the key used by the UE, generate the first encryption key and the first integrity protection key based on the updated key, and reestablish an RRC connection based on the first byte stream in the first MAC CE.

This embodiment of this application provides a communication method. After UE sends an RRC reestablishment request message to a base station, the base station may send a first MAC CE including an NCC and a first byte stream to the UE, where the first byte stream includes an encrypted RRC reestablishment message, that is, the base station may carry the NCC outside the encrypted RRC reestablishment message. Therefore, security of the RRC reestablishment message is improved while the UE obtains the NCC to update a key.

In some embodiments of this application, after the foregoing step 202, the communication method provided in this embodiment of this application further includes the following step 203 to step 207.

Step 203: The MAC layer of the UE parses the first MAC CE to obtain an NCC and a first byte stream.

Step 204: The MAC layer of the UE delivers the NCC and the first byte stream to RRC layer of the UE.

It can be understood that, after receiving the first MAC CE, the MAC layer of the UE may parse the first MAC CE to obtain the NCC and the first byte stream, and deliver the NCC and the first byte stream to the RRC layer of the UE by means of inter-layer interaction.

In some embodiments of this application, if the first MAC CE further carries first information or another message integrity authentication code MAC-I, the MAC layer of the UE may deliver the first information or the another MAC-I to the RRC layer of the UE together.

Step 205: The RRC layer of the UE updates, based on the NCC, a key used by the UE, and generates a first encryption key and a first integrity protection key based on the updated key.

In some embodiments of this application, in a case that an NCC corresponding to current key is the same as the NCC in the first MAC CE, the RRC layer of the UE may update, based on the current key, the key used by the UE; otherwise, the RRC layer of the UE may update, based on an NH corresponding to the NCC in the first MAC CE, the key used by the UE.

Step 206: The RRC layer of the UE requests a PDCP layer of the UE to process the first byte stream based on the first encryption key and the first integrity protection key.

Step 207: The PDCP layer of the UE processes the first byte stream based on the first encryption key and the first integrity protection key.

In some embodiments of this application, after the foregoing step 207, the communication method provided in this embodiment of this application further includes the following step 301 or step 302.

Step 301: The UE enters an idle state in a case that the PDCP layer of the UE fails to perform an integrity verification operation.

Step 302: The PDCP layer of the UE delivers a decrypted RRC reestablishment message to the RRC layer of the UE in a case that the PDCP layer of the UE successfully performs an integrity verification operation.

In some embodiments of this application, after the foregoing step 302, the communication method provided in this embodiment of this application further includes the following step 303 and step 304.

Step 303: The RRC layer of the UE reestablishes an RRC connection based on the decrypted RRC reestablishment message.

It can be understood that the RRC layer of the UE may process the decrypted RRC reestablishment message, and reestablish the RRC connection based on the RRC reestablishment message.

In some embodiments of this application, the foregoing step 303 may be specifically implemented by the following step 303a.

Step 303a: In a case that the NCC in the first MAC CE is the same as an NCC in the RRC reestablishment message, the RRC layer of the UE reestablishes the RRC connection based on the decrypted RRC reestablishment message.

In some embodiments of this application, in a case that the RRC reestablishment message includes the NCC, the RRC layer of the UE may further verify whether the NCC in the first MAC CE is the same as the NCC in the RRC reestablishment message. If the NCCs are different, the verification fails, and the UE enters an idle state. If the NCCs are the same, the RRC layer of the UE reestablishes the RRC connection based on the decrypted RRC reestablishment message.

In this way, because the RRC reestablishment message includes the NCC, it may be verified, based on the NCC, whether the NCC included in the first MAC CE is consistent with the NCC included in the RRC reestablishment message, thereby improving security.

Step 304: The UE sends an RRC reestablishment complete message to the base station.

In this embodiment of this application, the RRC reestablishment complete message is a message that is processed by the PDCP layer of the UE by using the first encryption key and the first integrity protection key.

It can be understood that the UE may send RRC Reestablishment Complete, that is, the RRC reestablishment complete message, to the base station, where encryption and integrity protection have been performed on the message and the message is transmitted on the SRB1.

In some embodiments of this application, the first byte stream corresponds to a first PDCP PDU, the first PDCP PDU includes an encrypted first MAC-I, and the encrypted first MAC-I is generated by the PDCP layer of the base station by performing an integrity protection operation on the RRC reestablishment message. The foregoing step 207 may be specifically implemented by the following step 207a to step 207c.

Step 207a: The PDCP layer of the UE parses the first PDCP PDU to obtain the encrypted RRC reestablishment message and the encrypted first MAC-I.

Step 207b: The PDCP layer of the UE performs a decryption operation on the encrypted RRC reestablishment message and the encrypted first MAC-I by using the first encryption key, to obtain a decrypted RRC reestablishment message and a decrypted first MAC-I.

Step 207c: The PDCP layer of the UE performs an integrity verification operation on the decrypted RRC reestablishment message by using the first integrity protection key and the decrypted first MAC-I.

In some embodiments of this application, the UE may enter an idle state in a case that the PDCP layer of the UE fails to perform the integrity verification operation.

In some embodiments of this application, in a case that the PDCP layer of the UE successfully performs the integrity verification operation, the PDCP layer of the UE may deliver the decrypted RRC reestablishment message to the RRC layer of the UE, and the RRC layer of the UE configures the PDCP layer of the UE to resume integrity protection and encryption by using the first encryption key and the first integrity protection key.

Specifically, the PDCP layer of the UE may parse the first PDCP PDU, obtain “PDCP SN”, “Data”, and “MAC-I”, decrypt the two information elements “Data” and “MAC-I” by using the first encryption key, and then perform integrity verification on the decrypted information element “Data” by using the first integrity protection key and the decrypted “MAC-I”. If the verification fails, the UE may enter an idle state, and the procedure ends. If the verification succeeds, the PDCP layer of the UE may return the decrypted “Data” to the RRC layer. “Data” corresponds to the encrypted RRC reestablishment message, and “MAC-I” corresponds to the encrypted first MAC-I.

In some embodiments of this application, a parameter used by the PDCP layer of the UE to perform the decryption operation and the integrity verification operation is a first parameter or a first parameter set.

In some embodiments of this application, the first parameter or the first parameter set includes at least one of the following: a COUNT value is 0, BEARER is a bearer identifier of a radio signaling bearer SRB1, and DIRECTION is a downlink direction.

In some embodiments of this application, a value of the downlink direction is 1.

In some embodiments of this application, the communication method provided in this embodiment of this application may further include the following step 208.

Step 208: The PDCP layer of the UE sets or increments a first state variable maintained by a PDCP entity corresponding to the SRB1 to 1 or by 1.

In this embodiment of this application, the first state variable is a variable corresponding to a COUNT value of a next PDCP SDU expected to be received.

In some embodiments of this application, the first state variable may be understood as an RX_NEXT variable.

It can be understood that, the PDCP entity of the SRB1 of the UE considers that the PDCP SDU whose COUNT value is 0 is successfully received. The RRC layer of the UE configures the PDCP layer of the UE to resume integrity protection and encryption by using the first encryption key and the first integrity protection key.

In some embodiments of this application, a parameter used by the PDCP layer of the UE to perform the decryption operation and the integrity verification operation is a second parameter or a second parameter set.

In some embodiments of this application, the second parameter or the second parameter set includes at least one of the following: all bits of a COUNT value are 1, all bits of a BEARER value are 1, and DIRECTION is a downlink direction.

It should be noted that the parameter used by the UE to perform the integrity verification operation and the decryption operation is the same as that used by the base station to perform the integrity protection operation and the encryption operation.

In some embodiments of this application, the first MAC CE includes first information, and the first information is a MAC-I generated by performing an integrity protection operation on the RRC reestablishment message. The foregoing step 207 may be specifically implemented by the following step 207d and step 207e.

Step 207d: The PDCP layer of the UE performs a decryption operation on the first byte stream by using the first encryption key, to obtain a decrypted RRC reestablishment message.

Step 207e: The PDCP layer of the UE performs an integrity verification operation on the decrypted RRC reestablishment message by using the first integrity protection key and the first information.

In some embodiments of this application, the UE may enter an idle state in a case that the PDCP layer of the UE fails to perform the integrity verification operation.

In some embodiments of this application, in a case that the PDCP layer of the UE successfully performs the integrity verification operation, the PDCP layer of the UE may deliver the decrypted RRC reestablishment message to the RRC layer of the UE, and configure the PDCP layer to resume integrity protection and encryption by using the first encryption key and the first integrity protection key.

In some embodiments of this application, the first MAC CE includes second information, and the second information is a MAC-I generated by performing an integrity protection operation on the NCC and the first byte stream. The foregoing step 207 may be specifically implemented by the following step 207f and step 207g.

Step 207f: The PDCP layer of the UE performs an integrity verification operation on the NCC and the first byte stream by using the first integrity protection key and the second information.

Step 207g: In a case that the PDCP layer of the UE successfully performs the integrity verification operation on the NCC and the first byte stream, the PDCP layer of the UE performs a decryption operation on the first byte stream by using the first encryption key, to obtain a decrypted RRC reestablishment message.

In some embodiments of this application, the UE may enter an idle state in a case that the PDCP layer of the UE fails to perform the integrity verification operation.

In some embodiments of this application, in a case that the PDCP layer of the UE successfully performs the integrity verification operation, the PDCP layer of the UE may deliver the decrypted RRC reestablishment message to the RRC layer of the UE, and configure the PDCP layer to resume integrity protection and encryption by using the first encryption key and the first integrity protection key.

It should be noted that, in this embodiment of this application, the parameter used by the PDCP layer of the UE to perform the decryption operation and the integrity verification operation is any one of the following: the first parameter, the first parameter set, the second parameter, and the second parameter set. Details are not described in this embodiment of this application. In addition, the parameter used by the UE to perform the integrity verification operation and the decryption operation is the same as that used by the base station to perform the integrity protection operation and the encryption operation.

An embodiment of this application provides a communication method. FIG. 3 is a flowchart of a communication method according to an embodiment of this application. As shown in FIG. 3, the communication method provided in this embodiment of this application may include the following step 401 and step 402.

Step 401: A base station receives an RRC reestablishment request message from UE.

Step 402: A MAC layer of the base station sends a first MAC CE to the UE.

In this embodiment of this application, the first MAC CE includes an NCC and a first byte stream, the first byte stream includes an encrypted RRC reestablishment message, and the RRC reestablishment message is used to instruct the UE to reestablish an RRC connection.

In some embodiments of this application, the first MAC CE is used to send the NCC and the encrypted RRC reestablishment message to the UE.

It can be understood that, the base station may send the first MAC CE to the UE afte receiving the RRC reestablishment request sent by the UE, so that the UE can update, based on the NCC in the first MAC CE, the key used by the UE, generate the first encryption key and the first integrity protection key based on the updated key, and reestablish an RRC connection based on the first byte stream in the first MAC CE.

In some embodiments of this application, the first MAC CE corresponds to a dedicated logical channel identifier (Logical Channel Identification, LCID), that is, an LCID is allocated to the first MAC CE. After receiving a MAC PDU including the first MAC CE, the UE can learn, by using a MAC subheader in the MAC PDU, that the LCID belongs to the f irst MAC CE.

This embodiment of this application provides a communication method. After receiving an RRC reestablishment request message sent by UE, a base station may send a first MAC CE including an NCC and a first byte stream to the UE, where the first byte stream includes an encrypted RRC reestablishment message. That is, the base station may send the NCC separately to the UE, and does not add the NCC to the RRC reestablishment message. Therefore, security of the RRC reestablishment message is improved while the UE obtains the NCC to update a key.

In some embodiments of this application, after the foregoing step 401, the communication method provided in this embodiment of this application further includes the following step 403 to step 405.

Step 403: An RRC layer of the base station updates a key used by the base station, and generates a first encryption key and a first integrity protection key based on the updated key.

In some embodiments of this application, after receiving the RRC reestablishment request message, the RRC layer of the base station may obtain an NCC stored in a UE context of the UE, and update, based on the NCC, the key used by the base station.

Step 404: The RRC layer of the base station instructs a PDCP layer of the base station to resume integrity protection and encryption by using the first encryption key and the first integrity protection key.

Step 405: The RRC layer of the base station generates the RRC reestablishment message, and requests the PDCP layer of the base station to apply security protection to the RRC reestablishment message.

It can be understood that, after the PDCP layer of the base station resumes integrity protection and encryption by using the first encryption key and the first integrity protection key, the RRC layer of the base station may generate the RRC reestablishment message, and request the PDCP layer of the base station to apply security protection to the RRC reestablishment message.

In some embodiments of this application, after the foregoing step 405, the communication method provided in this embodiment of this application further includes the following step 406 to step 408.

Step 406: The PDCP layer of the base station performs security protection on the RRC reestablishment message to generate the first byte stream, and delivers the first byte stream to the RRC layer of the base station.

In this embodiment of this application, the first byte stream includes the RRC reestablishment message on which security protection has been performed, and the security protection includes at least one of the following: an encryption operation and an integrity protection operation.

Step 407: The RRC layer of the base station delivers the first byte stream and an NCC stored in a UE context of the UE to the MAC layer of the base station.

Step 408: The MAC layer of the base station generates the first MAC CE based on the NCC and the first byte stream.

In some embodiments of this application, the first MAC CE is used to instruct the UE to reestablish an RRC connection or is used to send the NCC and the RRC reestablishment message on which security protection has been performed to the UE.

It can be understood that, after the MAC layer of the base station generates the first MAC CE based on the NCC and the first byte stream, the MAC layer of the base station may send the first MAC CE including the NCC and the first byte stream to the UE.

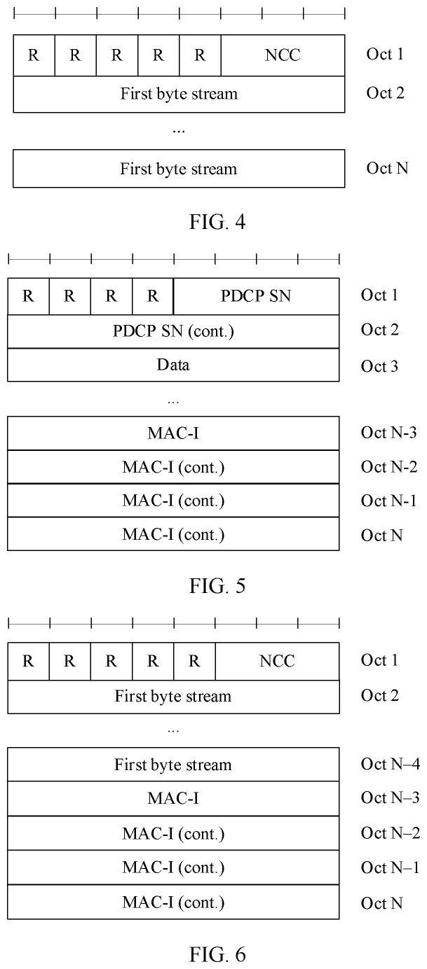

For example, FIG. 4 is a schematic structural diagram of a first MAC CE according to an embodiment of this application. The first MAC CE includes R, NCC, and a first byte stream, where R is reserved bits.

In some embodiments of this application, “the PDCP layer of the base station performs security protection on the RRC reestablishment message to generate the first byte stream” in the foregoing step 406 may be specifically implemented by the following step 406a and step 406b.

Step 406a: The PDCP layer of the base station performs an integrity protection operation on the RRC reestablishment message by using the first integrity protection key, to generate a first MAC-I.

Step 406b: The PDCP layer of the base station performs an encryption operation on the RRC reestablishment message and the first MAC-I by using the first encryption key, to generate a first PDCP PDU.

In this embodiment of this application, the first PDCP PDU corresponds to the first byte stream, and the first PDCP PDU includes the encrypted RRC reestablishment message and the first MAC-I.

In some embodiments of this application, the first PDCP PDU may be understood as the first byte stream, that is, the first PDCP PDU is the first byte stream.

It can be understood that in this embodiment, the PDCP layer of the base station performs security protection on the RRC reestablishment message, and the security protection includes an encryption operation and an integrity protection operation.

For example, FIG. 5 is a schematic structural diagram of a first PDCP PDU according to an embodiment of this application. An information element “PDCP SN” in the first PDCP PDU is 0, an information element “Data” corresponds to an encrypted RRC reestablishment message, and an information element “MAC-I” corresponds to an encrypted first MAC-I.

In this way, after generating the first MAC-I, the PDCP layer of the base station further performs the encryption operation on the first MAC-I by using the first encryption key, thereby improving security.

In some embodiments of this application, a parameter used by the PDCP layer of the base station to perform the encryption operation and the integrity protection operation is a first parameter or a first parameter set.

In some embodiments of this application, the first parameter or the first parameter set includes at least one of the following: a COUNT value is 0, BEARER is a bearer identifier of a Signaling Radio Bearer 1 (SRB1), and DIRECTION is a downlink direction.

In some embodiments of this application, a value of the downlink direction is 1.

In some embodiments of this application, the communication method provided in this embodiment of this application may further include the following step 409.

Step 409: The PDCP layer of the base station sets or increments a second variable maintained by a PDCP entity corresponding to the SRB1 to 1 or by 1.

In this embodiment of this application, the second variable is a variable corresponding to a COUNT value of a next PDCP SDU to be sent.

In some embodiments of this application, the second variable may be understood as a TX_NEXT variable.

It can be understood that the PDCP entity of the SRB1 allocates a COUNT value (that is, a value 0) to the RRC reestablishment message, performs security protection processing, and returns the processed message to the RRC layer instead of delivering the message to the RLC layer. In addition, the TX_NEXT variable is set to 1 or incremented by 1, thereby avoiding a problem of security degradation caused by an RRC message subsequently sent on the SRB1 using the same security protection parameter.

In some embodiments of this application, a parameter used by the PDCP layer of the base station to perform the encryption operation and the integrity protection operation is a second parameter or a second parameter set.

In some embodiments of this application, the second parameter or the second parameter set includes at least one of the following: all bits of a COUNT value are 1, all bits of a BEARER value are 1, and DIRECTION is a downlink direction.

In some embodiments of this application, the foregoing step 406 may be specifically implemented by the following step 406c to step 406e.

Step 406c: The PDCP layer of the base station performs an encryption operation on the RRC reestablishment message by using the first encryption key, to generate a first byte stream.

It can be understood that the first byte stream includes the encrypted RRC reestablishment message.

Step 406d: The PDCP layer of the base station performs an integrity protection operation on the RRC reestablishment message by using the first integrity protection key, to generate first information.

In this embodiment of this application, the first information is a MAC-I generated by performing the integrity protection operation on the RRC reestablishment message.

It can be understood that in this embodiment, the PDCP layer of the base station performs security protection on the RRC reestablishment message, and the security protection includes an encryption operation and an integrity protection operation.

In some embodiments of this application, a MAC-I generated when the PDCP layer of the base station performs an integrity protection operation on the RRC reestablishment message by using the first parameter or the first parameter set is different from a MAC-I generated when the PDCP layer of the base station performs an integrity protection operation on the RRC reestablishment message by using the second parameter or the second parameter set.

Step 406e: The PDCP layer of the base station delivers the first byte stream and the first information to the RRC layer of the base station.

In this embodiment of this application, the first MAC CE generated by the MAC layer of the base station includes the first byte stream, the NCC, and the first information, and the first information is delivered by the RRC layer of the base station to the MAC layer of the base station.

It can be understood that, after the RRC layer of the base station requests the PDCP layer of the base station to apply security protection to the RRC reestablishment message, and the PDCP layer of the base station performs the encryption operation and the integrity protection operation on the RRC reestablishment message to generate the first byte stream and the first information, the PDCP layer of the base station may return the first byte stream and the first information to the RRC layer of the base station, and then the RRC layer of the base station may deliver the first byte stream, the NCC, and the first information to the MAC layer of the base station, so that the MAC layer of the base station can generate the first MAC CE based on the NCC, the first byte stream, and the first information.

In some embodiments of this application, in a case that the RRC layer of the base station requests the PDCP layer of the base station to apply security protection to the RRC reestablishment message, the PDCP layer of the base station may perform only the encryption operation on the RRC reestablishment message.

In some embodiments of this application, the PDCP layer of the base station may deliver only the first byte stream to the RRC layer of the base station.

In some embodiments of this application, before the foregoing step 407, the communication method provided in this embodiment of this application further includes the following step 407a and step 407b.

Step 407a: The RRC layer of the base station requests the PDCP layer of the base station to perform an integrity protection operation on the NCC and the first byte stream.

In some embodiments of this application, when the RRC layer of the base station requests the PDCP layer of the base station to apply security protection to the RRC reestablishment message, and the RRC layer of the base station receives only the first byte stream returned by the PDCP layer of the base station, that is, when the PDCP layer of the base station does not perform the integrity protection operation on the RRC reestablishment message, the RRC layer of the base station may request the PDCP layer of the base station to perform the integrity protection operation on the NCC and the first byte stream.

In some embodiments of this application, the RRC layer of the base station may deliver the NCC and the first byte stream to the PDCP layer of the base station.

Step 407b: The PDCP layer of the base station performs the integrity protection operation on the NCC and the first byte stream by using the first integrity protection key, to generate a second MAC-I, and delivers the second MAC-I to the RRC layer of the base station.

In this embodiment of this application, the first MAC CE generated by the MAC layer of the base station includes the first byte stream, the NCC, and the second MAC-I, and the second MAC-I is delivered by the RRC layer of the base station to the MAC layer of the base station.

It can be understood that when the RRC layer of the base station receives the second MAC-I returned by the PDCP layer of the base station, the first byte stream, the NCC, and the second MAC-I may be delivered to the MAC layer of the base station, so that the MAC layer of the base station can generate the first MAC CE based on the NCC, the first byte stream, and the second MAC-I.

In some embodiments of this application, the second MAC-I may be second information.

In some embodiments of this application, a parameter used when the PDCP layer of the base station performs integrity protection on the NCC and the first byte stream by using the first integrity protection key is the same as a parameter used when the PDCP layer of the base station performs the encryption operation on the RRC reestablishment message by using the first encryption key.

In this way, when the PDCP layer of the base station does not perform the integrity protection operation on the RRC reestablishment message, the RRC layer of the base station may request the PDCP layer of the base station to perform the integrity protection operation on the NCC and the first byte stream to generate the second MAC-I, and then may deliver the first byte stream, the NCC, and the second MAC-I to the MAC layer of the base station, so that the MAC layer of the base station generates the first MAC CE, thereby improving flexibility and reliability of generating the first MAC CE by the base station.

In some embodiments of this application, before the foregoing step 408, the communication method provided in this embodiment of this application further includes the following step 408a and step 408b.

Step 408a: The MAC layer of the base station requests the PDCP layer of the base station to perform an integrity protection operation on the NCC and the first byte stream.

In some embodiments of this application, when the MAC layer of the base station receives only the first byte stream and the NCC that are delivered by the RRC layer of the base station, that is, when the PDCP layer of the base station does not perform the integrity protection operation on the RRC reestablishment message, the MAC layer of the base station may request the PDCP layer of the base station to perform the integrity protection operation on the first byte stream and the NCC.

In some embodiments of this application, the MAC layer of the base station may deliver the NCC and the first byte stream to the PDCP layer of the base station.

Step 408b: The PDCP layer of the base station performs integrity protection on the NCC and the first byte stream by using the first integrity protection key, to generate a third MAC-I, and delivers the third MAC-I to the MAC layer of the base station.

In this embodiment of this application, the first MAC CE generated by the MAC layer of the base station includes the first byte stream, the NCC, and the third MAC-I.

It can be understood that when the MAC layer of the base station receives the third MAC-I returned by the PDCP layer of the base station, the MAC layer of the base station may generate the first MAC CE based on the NCC, the first byte stream, and the third MAC-I.

In some embodiments of this application, the third MAC-I may be second information.

In some embodiments of this application, a parameter used when the PDCP layer of the base station performs integrity protection on the NCC and the first byte stream by using the first integrity protection key is the same as a parameter used when the PDCP layer of the base station performs the encryption operation on the RRC reestablishment message by using the first encryption key.

In this way, when the PDCP layer of the base station does not perform the integrity protection operation on the RRC reestablishment message, the MAC layer of the base station may request the PDCP layer of the base station to perform the integrity protection operation on the NCC and the first byte stream to generate the third MAC-I. Then, the MAC layer of the base station may generate the first MAC CE based on the NCC, the first byte stream, and the third MAC-I returned by the PDCP layer of the base station, thereby improving flexibility and reliability of generating the first MAC CE by the base station. In addition to the first byte stream, integrity protection is also performed on the NCC, thereby improving security.

It should be noted that, in this embodiment of this application, the parameter used by the PDCP layer of the base station to perform the encryption operation and the integrity protection operation is any one of the following: the first parameter, the first parameter set, the second parameter, and the second parameter set.

For example, FIG. 6 is a schematic structural diagram of a first MAC CE according to an embodiment of this application. The first MAC CE includes R, an NCC, a first byte stream, and a MAC-I, and R is reserved bits.

In some embodiments of this application, the RRC reestablishment message is no longer transmitted via the SRB1 like a regular RRC message, but the RRC layer of the base station performs security protection on the message through inter-layer interaction with the PDCP layer. Then, the RRC reestablishment message obtained after the security protection is delivered to the MAC layer through inter-layer interaction with the MAC layer, and is carried in a MAC CE as a byte stream and sent to the UE. The MAC CE also carries the NCC used to update a key. Correspondingly, the UE first updates, based on the NCC in the MAC CE, the key used by the UE, and then performs security-related processing on the RRC reestablishment message based on the updated key.

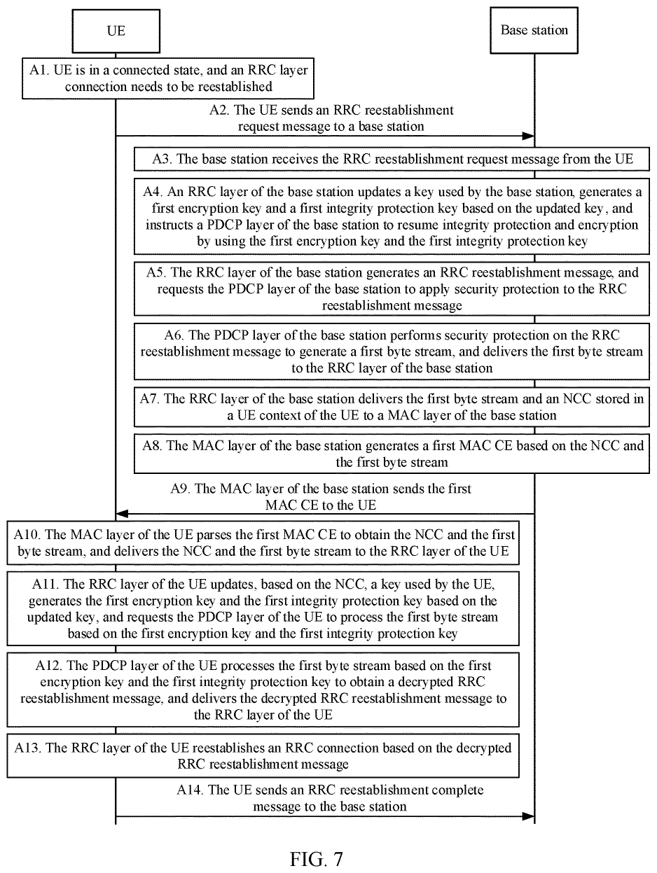

In some embodiments of this application, as shown in FIG. 7, the communication method provided in this embodiment of this application may include the following step A1 to step A14.
A1. UE is in a connected state, and an RRC layer connection needs to be reestablished.
A2. The UE sends an RRC reestablishment request message to a base station.
A3. The base station receives the RRC reestablishment request message from the UE.
A4. An RRC layer of the base station updates a key used by the base station, generates a first encryption key and a first integrity protection key based on the updated key, and instructs a PDCP layer of the base station to resume integrity protection and encryption by using the first encryption key and the first integrity protection key.
A5. The RRC layer of the base station generates an RRC reestablishment message, and requests the PDCP layer of the base station to apply security protection to the RRC reestablishment message.
A6. The PDCP layer of the base station performs security protection on the RRC reestablishment message to generate a first byte stream, and delivers the first byte stream to the RRC layer of the base station.
A7. The RRC layer of the base station delivers the first byte stream and an NCC stored in a UE context of the UE to a MAC layer of the base station.
A8. The MAC layer of the base station generates a first MAC CE based on the NCC and the first byte stream.
A9. The MAC layer of the base station sends the first MAC CE to the UE.
A10. The MAC layer of the UE parses the first MAC CE to obtain the NCC and the first byte stream, and delivers the NCC and the first byte stream to the RRC layer of the UE.
A11. The RRC layer of the UE updates, based on the NCC, a key used by the UE, generates the first encryption key and the first integrity protection key based on the updated key, and requests the PDCP layer of the UE to process the first byte stream based on the first encryption key and the first integrity protection key.
A12. The PDCP layer of the UE processes the first byte stream based on the first encryption key and the first integrity protection key to obtain a decrypted RRC reestablishment message, and delivers the decrypted RRC reestablishment message to the RRC layer of the UE.
A13. The RRC layer of the UE reestablishes an RRC connection based on the decrypted RRC reestablishment message.
A14. The UE sends an RRC reestablishment complete message to the base station.

It should be noted that for related descriptions in the foregoing step A1 to step A14, refer to the descriptions in the foregoing embodiment. Details are not described herein again.

The foregoing method embodiments or the implementations in the method embodiments may be separately executed, or any two or more thereof may be executed together. This may be specifically determined according to an actual use requirement, and is not limited in the embodiments of this application.

The communication method provided in the embodiments of this application may be executed by a communication apparatus. In the embodiments of this application, an example in which the communication apparatus executes the communication method is used to describe the communication apparatus provided in the embodiments of this application.

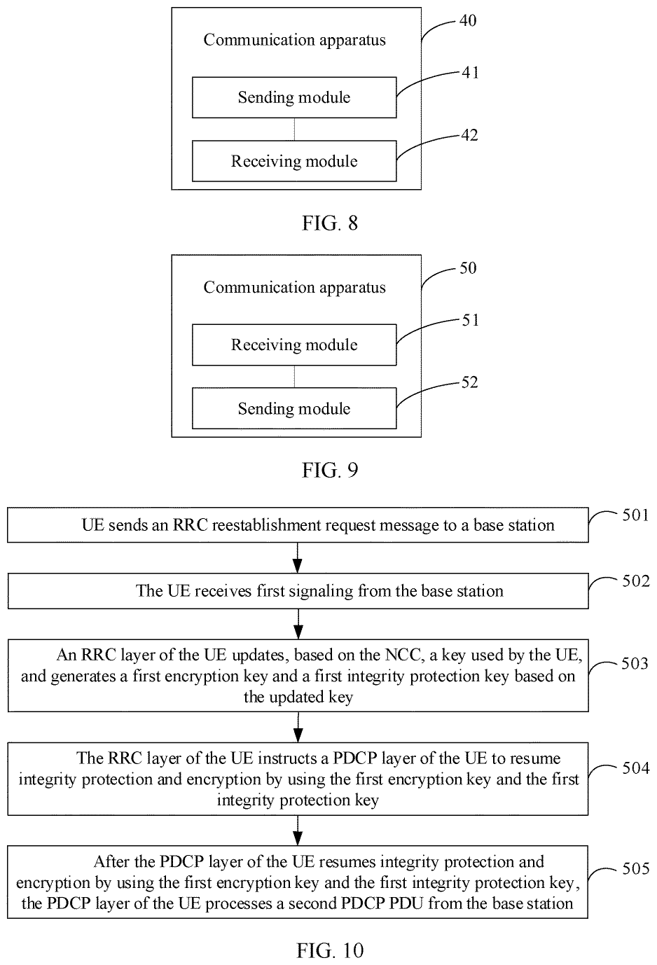

FIG. 8 is a schematic structural diagram of a communication apparatus according to an embodiment of this application, applied to UE. As shown in FIG. 8, the communication apparatus 40 may include a sending module 41 and a receiving module 42.

The sending module 41 is configured to send an RRC reestablishment request message to a base station.

The receiving module 42 is configured to receive a first MAC CE from the base station, where the first MAC CE includes an NCC and a first byte stream, the first byte stream includes an encrypted RRC reestablishment message, and the RRC reestablishment message is used to instruct the UE to reestablish an RRC connection.

This embodiment of this application provides a communication apparatus. After UE sends an RRC reestablishment request message to a base station, the base station may send a first MAC CE including an NCC and a first byte stream to the UE, where the first byte stream includes an encrypted RRC reestablishment message, that is, the base station may carry the NCC outside the encrypted RRC reestablishment message. Therefore, security of the RRC reestablishment message is improved while the UE obtains the NCC to update a key.

In some implementations, the communication apparatus provided in this embodiment of this application further includes a parsing module, a delivering module, a processing module, and a requesting module. The parsing module is configured to: after the receiving module 42 receives the first MAC CE from the base station, parse the first MAC CE to obtain the NCC and the first byte stream. The delivering module is configured to deliver the NCC and the first byte stream that are obtained by the parsing module by means of parsing to an RRC layer of the UE. The processing module is configured to: update, based on the NCC delivered by the delivering module, a key used by the UE, and generate a first encryption key and a first integrity protection key based on the updated key. The requesting module is configured to request a PDCP layer of the UE to process the first byte stream based on the first encryption key and the first integrity protection key. The processing module is further configured to process the first byte stream based on the first encryption key and the first integrity protection key.

In some implementations, the first byte stream corresponds to a first PDCP PDU, the first PDCP PDU includes an encrypted first MAC-I, and the encrypted first MAC-I is generated by a PDCP layer of the base station by performing an integrity protection operation on the RRC reestablishment message. The processing module is specifically configured to: parse the first PDCP PDU to obtain the encrypted RRC reestablishment message and the encrypted first MAC-I; perform a decryption operation on the encrypted RRC reestablishment message and the encrypted first MAC-I by using the first encryption key, to obtain a decrypted RRC reestablishment message and a decrypted first MAC-I; and perform an integrity verification operation on the decrypted RRC reestablishment message by using the first integrity protection key and the decrypted first MAC-I.

In some implementations, the first MAC CE includes first information, and the first information is a MAC-I generated by performing an integrity protection operation on the RRC reestablishment message. The processing module is specifically configured to: perform a decryption operation on the first byte stream by using the first encryption key, to obtain a decrypted RRC reestablishment message; and perform an integrity verification operation on the decrypted RRC reestablishment message by using the first integrity protection key and the first information.

In some implementations, the first MAC CE includes second information, and the second information is a MAC-I generated by performing an integrity protection operation on the NCC and the first byte stream. The processing module is specifically configured to: perform an integrity verification operation on the NCC and the first byte stream by using the first integrity protection key and the second information; and in a case that the PDCP layer of the UE successfully performs the integrity verification operation on the NCC and the first byte stream, perform a decryption operation on the first byte stream by using the first encryption key, to obtain a decrypted RRC reestablishment message.

In some implementations, a parameter used by the PDCP layer of the UE to perform the decryption operation and the integrity verification operation is a first parameter or a first parameter set; and the first parameter or the first parameter set includes at least one of the following: a COUNT value is 0, BEARER is a bearer identifier of a Signaling Radio Bearer 1 (SRB1), and DIRECTION is a downlink direction.

In some implementations, the processing module is further configured to set a first state variable maintained by a PDCP entity corresponding to the SRB1 to 1 or by 1, where the first state variable is a variable corresponding to a COUNT value of a next PDCP service data unit SDU expected to be received.

In some implementations, a parameter used by the PDCP layer of the UE to perform the decryption operation and the integrity verification operation is a second parameter or a second parameter set; and the second parameter or the second parameter set includes at least one of the following: all bits of a COUNT value are 1, all bits of a BEARER value are 1, and DIRECTION is a downlink direction.

In some implementations, the processing module is further configured to: after the first byte stream is processed based on the first encryption key and the first integrity protection key, enter an idle state in a case that the PDCP layer of the UE fails to perform the integrity verification operation. The delivering module is further configured to: after the processing module processes the first byte stream based on the first encryption key and the first integrity protection key, deliver the decrypted RRC reestablishment message to the RRC layer of the UE in a case that the PDCP layer of the UE successfully performs the integrity verification operation.

In some implementations, the processing module is further configured to: after the delivering module delivers the decrypted RRC reestablishment message to the RRC layer of the UE, reestablish the RRC connection based on the decrypted RRC reestablishment message. The sending module 41 is further configured to send an RRC reestablishment complete message to the base station, where the RRC reestablishment complete message is a message processed by the PDCP layer of the UE by using the first encryption key and the first integrity protection key.

In some implementations, the processing module is specifically configured to: in a case that the NCC in the first MAC CE is the same as an NCC in the RRC reestablishment message, reestablish the RRC connection based on the decrypted RRC reestablishment message.

The communication apparatus provided in this embodiment of this application can implement the processes implemented by the UE in the foregoing method embodiment, and achieve a same technical effect. To avoid repetition, details are not described herein again.

FIG. 9 is another schematic structural diagram of a communication apparatus according to an embodiment of this application, applied to a base station. As shown in FIG. 9, the communication apparatus 50 may include a receiving module 51 and a sending module 52.

The receiving module 51 is configured to receive an RRC reestablishment request message from UE.

The sending module 52 is configured to send a first MAC CE to the UE, where the first MAC CE includes an NCC and a first byte stream, the first byte stream includes an encrypted RRC reestablishment message, and the RRC reestablishment message is used to instruct the UE to reestablish an RRC connection.

This embodiment of this application provides a communication apparatus. After receiving an RRC reestablishment request message sent by UE, a base station may send a first MAC CE including an NCC and a first byte stream to the UE, where the first byte stream includes an encrypted RRC reestablishment message. That is, the base station may send the NCC separately to the UE, and does not add the NCC to the RRC reestablishment message. Therefore, security of the RRC reestablishment message is improved while the UE obtains the NCC to update a key.

In some implementations, the communication apparatus provided in this embodiment of this application further includes a processing module and an instructing module. The processing module is configured to: after the receiving module 51 receives the RRC reestablishment request message from the UE, update a key used by the base station, and generate a first encryption key and a first integrity protection key based on the updated key. The instructing module is configured to instruct a PDCP layer of the base station to resume integrity protection and encryption by using the first encryption key and the first integrity protection key that are generated by the processing module. The processing module is further configured to: generate the RRC reestablishment message, and request the PDCP layer of the base station to apply security protection to the RRC reestablishment message.

In some implementations, the communication apparatus provided in this embodiment of this application further includes a delivering module and a generation module. The processing module is further configured to: after the RRC reestablishment message is generated and the PDCP layer of the base station is requested to apply security protection to the RRC reestablishment message, apply security protection to the RRC reestablishment message to generate the first byte stream, and deliver the first byte stream to the RRC layer of the base station, where the first byte stream includes the RRC reestablishment message on which security protection has been performed, and the security protection includes at least one of the following: an encryption operation and an integrity protection operation. The delivering module is configured to deliver the first byte stream and an NCC stored in a UE context of the UE to the MAC layer of the base station. The generation module is configured to generate the first MAC CE based on the NCC and the first byte stream.

In some implementations, the generation module is specifically configured to: perform an integrity protection operation on the RRC reestablishment message by using the first integrity protection key, to generate a first MAC-I; and perform an encryption operation on the RRC reestablishment message and the first MAC-I by using the first encryption key, to generate a first PDCP PDU, where the first PDCP PDU corresponds to the first byte stream, and the first PDCP PDU includes the encrypted RRC reestablishment message and the first MAC-I.

In some implementations, the processing module is specifically configured to: perform an encryption operation on the RRC reestablishment message by using the first encryption key, to generate the first byte stream; perform an integrity protection operation on the RRC reestablishment message by using the first integrity protection key, to generate first information, where the first information is a MAC-I generated by performing the integrity protection operation on the RRC reestablishment message; and deliver the first byte stream and the first information to the RRC layer of the base station, where the first MAC CE generated by the MAC layer of the base station includes the first byte stream, the NCC, and the first information, and the first information is delivered by the RRC layer of the base station to the MAC layer of the base station.

In some implementations, the communication apparatus provided in this embodiment of this application further includes a requesting module. The requesting module is configured to: before the delivering module delivers the first byte stream and the NCC stored in the UE context of the UE to the MAC layer of the base station, request the PDCP layer of the base station to perform an integrity protection operation on the NCC and the first byte stream. The processing module is further configured to: perform the integrity protection operation on the NCC and the first byte stream by using the first integrity protection key, to generate a second MAC-I, and deliver the second MAC-I to the RRC layer of the base station, where the first MAC CE generated by the MAC layer of the base station includes the first byte stream, the NCC, and the second MAC-I, and the second MAC-I is delivered by the RRC layer of the base station to the MAC layer of the base station.

In some implementations, the communication apparatus provided in this embodiment of this application further includes a requesting module. The requesting module is configured to: before the generating module generates the first MAC CE based on the NCC and the first byte stream, request the PDCP layer of the base station to perform an integrity protection operation on the NCC and the first byte stream. The processing module is configured to: perform integrity protection on the NCC and the first byte stream by using the first integrity protection key, to generate a third MAC-I, and deliver the third MAC-I to the MAC layer of the base station, where the first MAC CE generated by the MAC layer of the base station includes the first byte stream, the NCC, and the third MAC-I.

In some implementations, a parameter used by the PDCP layer of the base station to perform the encryption operation and the integrity protection operation is a first parameter or a first parameter set; and the first parameter or the first parameter set includes at least one of the following: a COUNT value is 0, BEARER is a bearer identifier of a Signaling Radio Bearer 1 (SRB1), and DIRECTION is a downlink direction.

In some implementations, the processing module is further configured to set or increment a second variable maintained by a PDCP entity corresponding to the SRB1 to 1 or by 1, where the second variable is a variable corresponding to a COUNT value of a next PDCP service data unit SDU to be sent.

In some implementations, a parameter used by the PDCP layer of the base station to perform the encryption operation and the integrity protection operation is a second parameter or a second parameter set; and
the second parameter or the second parameter set includes at least one of the following: all bits of a COUNT value are 1, all bits of a BEARER value are 1, and DIRECTION is a downlink direction.

The communication apparatus provided in this embodiment of this application can implement the processes implemented by the base station in the foregoing method embodiment, and achieve a same technical effect. To avoid repetition, details are not described herein again.

An embodiment of this application provides a communication method. FIG. 10 is a flowchart of a communication method according to an embodiment of this application. As shown in FIG. 10, the communication method provided in this embodiment of this application may include the following step 501 to step 505.

Step 501: UE sends an RRC reestablishment request message to a base station.

In some embodiments of this application, in a case that the UE is in an RRC connected state but an RRC connection needs to be reestablished, for example, the UE in the connected state has a radio link failure or an integrity check failure, the UE may execute a cell selection process to select a target cell to initiate an RRC reestablishment process, and send the RRC reestablishment request message to the base station in which the target cell is located via an SRB0.

Step 502: The UE receives first signaling from the base station.

In this embodiment of this application, the first signaling is used to request the UE to update a key used by the UE, the first signaling includes an NCC, and the first signaling is a second MAC CE or a PDCP control PDU.

Step 503: An RRC layer of the UE updates, based on the NCC, a key used by the UE, and generates a first encryption key and a first integrity protection key based on the updated key.

In some embodiments of this application, after receiving the first signaling, the RRC of the UE may parse the first signaling to obtain the NCC.

In some embodiments of this application, in a case that an NCC corresponding to a current key is the same as an NCC in the second MAC CE, the RRC layer of the UE may update, based on the current key, the key used by the UE; otherwise, the RRC layer of the UE may update, based on an NH corresponding to the NCC in the second MAC CE, the key used by the UE.

In some embodiments of this application, in a case that an NCC corresponding to current key is the same as an NCC in the PDCP control PDU, the RRC layer of the UE may update, based on the current key, the key used by the UE; otherwise, the RRC layer of the UE may update, based on an NH corresponding to the NCC in the PDCP control PDU, the key used by the UE.

Step 504: The RRC layer of the UE instructs a PDCP layer of the UE to resume integrity protection and encryption by using the first encryption key and the first integrity protection key.

Step 505: After the PDCP layer of the UE resumes integrity protection and encryption by using the first encryption key and the first integrity protection key, the PDCP layer of the UE processes a second PDCP PDU from the base station.

It should be noted that, before the PDCP layer of the UE resumes integrity protection and encryption by using the first encryption key and the first integrity protection key, if a PDCP entity corresponding to an SRB1 of the UE receives a PDCP PDU, for example, the second PDCP PDU is received first because of retransmission of the first signaling, the PDCP entity corresponding to the SRB1 of the UE first does not process the second PDCP PDU until the first signaling is received, and the PDCP layer of the UE can process the second PDCP PDU only after the PDCP layer of the UE resumes integrity protection and encryption by using the first encryption key and the first integrity protection key.

In this embodiment of this application, the second PDCP PDU includes an RRC reestablishment message on which integrity protection and encryption have been performed, and the RRC reestablishment message is used to instruct the UE to reestablish an RRC connection.

It can be understood that, the PDCP layer of the UE processes the second PDCP PDU from the base station after resuming integrity protection and encryption by using the first encryption key and the first integrity protection key.

This embodiment of this application provides a communication method. After sending an RRC reestablishment request message to a base station, UE may receive first signaling that is from the base station and that is used to request the UE to update a key used by the UE, where the first signaling includes an NCC. Therefore, an RRC layer of the UE may update, based on the NCC included in the first signaling, the key used by the UE, and generate a first encryption key and a first integrity protection key based on the updated key, and instruct a PDCP layer of the UE to resume integrity protection and encryption by using the first encryption key and the first integrity protection key. Then, the PDCP layer of the UE may process a second PDCP PDU from the base station after resuming integrity protection and encryption by using the first encryption key and the first integrity protection key, where the second PDCP PDU includes an RRC reestablishment message on which integrity protection and encryption have been performed, and the RRC reestablishment message is used to instruct the UE to reestablish an RRC connection. In other words, the PDCP layer of the UE first resumes integrity protection and encryption and then processes the second PDCP PDU from the base station. Therefore, integrity protection and encryption may be implemented on the RRC reestablishment message, thereby improving security of the RRC reestablishment message.

In some embodiments of this application, in a case that the first signaling is a second MAC CE, the foregoing step 502 may be specifically implemented by the following step 502a and step 502b.

Step 502a: A MAC layer of the UE receives the second MAC CE from the base station.

Step 502b: The MAC layer of the UE parses the second MAC CE to obtain the NCC, and delivers the NCC to the RRC layer of the UE.

It can be understood that, after receiving the second MAC CE, the MAC layer of the UE may parse the second MAC CE to obtain the NCC, and deliver the NCC to the RRC layer of the UE by means of inter-layer interaction.

In some embodiments of this application, if the second MAC CE further carries another MAC-I, the MAC layer of the UE may deliver the another MAC-I to the RRC layer of the UE together.

In some embodiments of this application, in a case that the first signaling is a PDCP control PDU, the foregoing step 502 may be specifically implemented by the following steps 502c and 502d.

Step 502c: The PDCP layer of the UE receives the PDCP control PDU from the base station.

Step 502d: The PDCP layer of the UE parses the PDCP control PDU to obtain the NCC, and delivers the NCC to the RRC layer of the UE.

It can be understood that, after receiving the PDCP control PDU, the PDCP layer of the UE may parse the PDCP control PDU to obtain the NCC, and deliver the NCC to the RRC layer of the UE by means of inter-layer interaction.

In some embodiments of this application, the PDCP layer of the UE may be specifically the PDCP entity corresponding to the SRB1.

In some embodiments of this application, if the PDCP control PDU further carries another MAC-I, the PDCP layer of the UE may deliver the another MAC-I to the RRC layer of the UE together.

In some embodiments of this application, the first signaling includes third information, and the third information is a MAC-I generated by performing an integrity protection operation on the NCC. The foregoing step 504 may be specifically implemented by the following step 504a to step 504c.

Step 504a: The RRC layer of the UE requests the PDCP layer of the UE to perform an integrity verification operation on the NCC by using the first integrity protection key and the third information.

Step 504b: The PDCP layer of the UE performs the integrity verification operation on the NCC by using the first integrity protection key and the third information.

Step 504c: In a case that the PDCP layer of the UE successfully performs the integrity verification operation on the NCC, the RRC layer of the UE instructs the PDCP layer of the UE to resume integrity protection and encryption by using the first encryption key and the first integrity protection key.

In some embodiments of this application, in a case that the first signaling is a second MAC CE, the RRC layer of the UE may request the PDCP layer of the UE to perform an integrity verification operation on the NCC by using the first integrity protection key and a MAC-I included in the second MAC CE.

In some embodiments of this application, in a case that the first signaling is a PDCP control PDU, the RRC layer of the UE may request the PDCP layer of the UE to perform an integrity verification operation on the NCC by using the first integrity protection key and a MAC-I included in the PDCP control PDU.

In some embodiments of this application, a parameter used by the PDCP layer of the UE to perform the integrity verification operation on the NCC is a second parameter or a second parameter set.

In some embodiments of this application, the second parameter or the second parameter set includes at least one of the following: all bits of a COUNT value are 1, all bits of a BEARER value are 1, and DIRECTION is a downlink direction.

In some embodiments of this application, the communication method provided in this embodiment of this application may further include the following step 506.

Step 506: The UE enters an idle state in a case that the PDCP layer of the UE fails to perform the integrity verification operation on the NCC.

In some embodiments of this application, in a case that the PDCP layer of the UE successfully performs the integrity verification operation on the NCC, the PDCP layer of the UE may be configured to resume integrity protection and encryption by using the first encryption key and the first integrity protection key.

In some embodiments of this application, “the PDCP layer of the UE processes a second PDCP PDU from the base station” in the foregoing step 505 may be specifically implemented by the following step 505a.

Step 505a: The PDCP layer of the UE performs a decryption operation and an integrity verification operation on the second PDCP PDU by using the first encryption key and the first integrity protection key, and delivers a decrypted RRC reestablishment message to the RRC layer of the UE.

It can be understood that, because the PDCP layer of the UE resumes integrity protection and encryption by using the first encryption key and the first integrity protection key, the PDCP layer of the UE may perform the decryption operation and the integrity verification operation on the received PDCP PDU to obtain the decrypted RRC reestablishment message, and deliver the decrypted RRC reestablishment message to the RRC layer of the UE.

In some embodiments of this application, the communication method provided in this embodiment of this application may further include the following step 601 and step 602.

Step 601: The RRC layer of the UE reestablishes an RRC connection based on the decrypted RRC reestablishment message.

It can be understood that the RRC layer of the UE may process the decrypted RRC reestablishment message, and reestablish the RRC connection based on the RRC reestablishment message.

Step 602: The UE sends an RRC reestablishment complete message to the base station.

In this embodiment of this application, the RRC reestablishment complete message is a message that is processed by the PDCP layer of the UE by using the first encryption key and the first integrity protection key.

It can be understood that the UE may send the RRC reestablishment complete message to the base station, where encryption and integrity protection have been performed on the message and the message is transmitted on the SRB1.

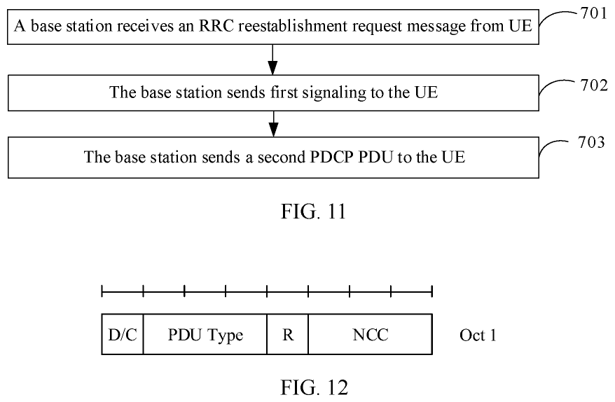

An embodiment of this application provides a communication method. FIG. 11 is a flowchart of a communication method according to an embodiment of this application. As shown in FIG. 11, the communication method provided in this embodiment of this application may include the following steps 701 to 703.

Step 701: A base station receives an RRC reestablishment request message from UE.

Step 702: The base station sends first signaling to the UE.

In this embodiment of this application, the first signaling is used to request the UE to update a key used by the UE, the first signaling includes an NCC, and the first signaling is a second MAC CE or a PDCP control PDU.

Step 703: The base station sends a second PDCP PDU to the UE.

In this embodiment of this application, the second PDCP PDU includes an RRC reestablishment message on which integrity protection and encryption have been performed, and the RRC reestablishment message is used to instruct the UE to reestablish an RRC connection.

This embodiment of this application provides a communication method. After receiving an RRC reestablishment request message sent by UE, a base station may send, to the UE, first signaling that is used to request the UE to update a key used by the UE, where the first signaling includes an NCC; and send, to the UE, a second PDCP PDU that is used to instruct the UE to reestablish an RRC connection, where the second PDCP PDU includes an RRC reestablishment message on which integrity protection and encryption have been performed. Therefore, the NCC and the RRC reestablishment message are separate, thereby improving security of the RRC reestablishment message.

In some embodiments of this application, before the foregoing step 703, the communication method provided in this embodiment of this application further includes the following step 704 and step 705.

Step 704: An RRC layer of the base station updates a key used by the base station, and generates a first encryption key and a first integrity protection key based on the updated key.

In some embodiments of this application, after receiving the RRC reestablishment request message sent by the UE, the RRC layer of the base station may obtain an NCC stored in a UE context of the UE, and then update, based on the NCC, the key used by the base station.

Step 705: The RRC layer of the base station instructs a PDCP layer of the base station to resume integrity protection and encryption by using the first encryption key and the first integrity protection key.

It should be noted that, when generating the first encryption key and the first integrity protection key, the RRC layer of the base station may instruct the PDCP layer of the base station to resume integrity protection and encryption by using the first encryption key and the first integrity protection key; or before the PDCP layer of the base station generates the PDCP control PDU, the RRC layer of the base station may instruct the PDCP layer of the base station to resume integrity protection and encryption by using the first encryption key and the first integrity protection key; or before the base station sends the PDCP control PDU to the UE, the RRC layer of the base station may instruct the PDCP layer of the base station to resume integrity protection and encryption by using the first encryption key and the first integrity protection key. This is not limited in this embodiment of this application.

In some embodiments of this application, the foregoing step 702 may be specifically implemented by the following step 702a to step 702c.

Step 702a: An RRC layer of the base station delivers an NCC stored in a UE context of the UE to a MAC layer of the base station.

In some embodiments of this application, the RRC layer of the base station may deliver the NCC to the MAC layer of the UE by means of inter-layer interaction.

Step 702b: The MAC layer of the base station generates the second MAC CE based on the NCC.

In this embodiment of this application, the second MAC CE is used to request the UE to update the key used by the UE, and the second MAC CE includes the NCC.

In some embodiments of this application, the second MAC CE is used to send the NCC to the UE.

Step 702c: The base station sends the second MAC CE to the UE.

In some embodiments of this application, the second MAC CE corresponds to a dedicated LCID, that is, an LCID is allocated to the second MAC CE. After receiving a MAC PDU including the second MAC CE, the UE can learn, by using the LCID in a MAC subheader in the MAC PDU, that the LCID belongs to the second MAC CE. In this way, it is unnecessary to occupy at least two bits to indicate what message is sent, thereby saving signaling overheads.

In some embodiments of this application, the foregoing step 702a may be specifically implemented by the following step 702a1 to step 702a3.

Step 702a1: The RRC layer of the base station requests a PDCP layer of the base station to perform an integrity protection operation on the NCC by using the first integrity protection key.

Step 702a2: The PDCP layer of the base station performs the integrity protection operation on the NCC by using the first integrity protection key, to generate a fourth MAC-I, and delivers the fourth MAC-I to the RRC layer of the base station.

In some embodiments of this application, the fourth MAC-I may be third information.

Step 702a3: The RRC layer of the base station delivers the NCC and the fourth MAC-I to the MAC layer of the base station.

In some embodiments of this application, the second MAC CE includes the NCC and the fourth MAC-I.

It can be understood that the MAC layer of the base station may generate the second MAC CE based on the NCC and the fourth MAC-I.

In some embodiments of this application, a parameter used by the PDCP layer of the base station to perform the integrity protection operation on the NCC is a second parameter or a second parameter set.

In some embodiments of this application, the second parameter or the second parameter set includes at least one of the following: all bits of a COUNT value are 1, all bits of a BEARER value are 1, and DIRECTION is a downlink direction.

In this way, integrity protection has been performed on the NCC, thereby improving security.

In some embodiments of this application, the foregoing step 702b may be specifically implemented by the following step 702b1 to step 702b3.

Step 702b1: The MAC layer of the base station requests a PDCP layer of the base station to perform an integrity protection operation on the NCC by using the first integrity protection key.

Step 702b2: The PDCP layer of the base station performs the integrity protection operation on the NCC by using the first integrity protection key, to generate a fifth MAC-I, and delivers the fifth MAC-I to the MAC layer of the base station.

In some embodiments of this application, the fifth MAC-I may be third information.

Step 702b3: The MAC layer of the base station generates the second MAC CE based on the NCC and the fifth MAC-I.

In this embodiment of this application, the second MAC CE includes the NCC and the fifth MAC-I.

In some embodiments of this application, in a case that the RRC layer of the base station delivers only the NCC stored in the UE context of the UE to the MAC layer of the base station, that is, in a case that integrity protection operation is not performed on the NCC, the MAC layer of the base station may request the PDCP layer of the UE to perform the integrity protection operation on the NCC by using the first integrity protection key, or perform the integrity protection operation on a byte or a byte stream including the NCC.

In this way, integrity protection has been performed on the NCC, thereby improving security.

In some embodiments of this application, the foregoing step 702 may be specifically implemented by the following step 702d to step 702f.

Step 702d: The RRC layer of the base station delivers an NCC stored in a UE context of the UE to a PDCP layer of the base station.

In some embodiments of this application, after receiving the RRC reestablishment message, the RRC layer of the base station may obtain the NCC stored in the UE context of the UE.

In some embodiments of this application, the RRC layer of the base station may update, based on the NCC, the key used by the base station, and generate the first encryption key and the first integrity protection key based on the updated key.

In some embodiments of this application, the RRC layer of the base station may deliver the NCC to the PDCP layer of the UE by means of inter-layer interaction.

Step 702e: The PDCP layer of the base station generates a PDCP control PDU based on the NCC.

In this embodiment of this application, the PDCP control PDU is used to request the UE to update the key used by the UE, and the PDCP control PDU includes the NCC.

In some embodiments of this application, the PDCP control PDU corresponds to a dedicated PDU Type value, that is, a PDU Type value is allocated to the PDCP control PDU. After the UE receives the PDCP control PDU and a PDU Type value of the PDCP control PDU is the dedicated PDU Type value, the UE can learn that the PDU Type value belongs to the PDCP control PDU.

For example, FIG. 12 is a schematic structural diagram of a PDCP control PDU according to an embodiment of this application. D/C is used to indicate a control PDU or a data PDU, Pa DU Type is used to indicate a type of a control PDU, R is a reserved bit, and an NCC is an NCC delivered by an upper layer.

Step 702f: The base station sends the PDCP control PDU to the UE.

In some embodiments of this application, the PDCP control PDU is used to request the UE to update the key used by the UE.

In some embodiments of this application, the foregoing step 702e may be specifically implemented by the following step 702e1 and step 702e2.

Step 702e1: The PDCP layer of the base station performs an integrity protection operation on the NCC by using the first integrity protection key, to generate a sixth MAC-I.

In some embodiments of this application, the sixth MAC-I may be third information.

Step 702e2: The PDCP layer of the base station generates the PDCP control PDU based on the NCC and the sixth MAC-I.

In this embodiment of this application, the PDCP control PDU includes the sixth MAC-I.

In some embodiments of this application, a parameter used by the PDCP layer of the base station to perform the integrity protection operation on the NCC is a second parameter or a second parameter set.

In this way, integrity protection has been performed on the NCC, thereby improving security.

In some embodiments of this application, the foregoing step 703 may be specifically implemented by the following step 703a to step 703d.

Step 703a: The RRC layer of the base station generates the RRC reestablishment message, and delivers the RRC reestablishment message to the PDCP layer of the base station.

In some embodiments of this application, after generating the RRC reestablishment message, the RRC layer of the base station may deliver the RRC reestablishment message to the PDCP layer corresponding to the SRB1 as a PDCP SDU.

Step 703b: The PDCP layer of the base station performs an encryption operation and an integrity protection operation on the RRC reestablishment message by using the first encryption key and the first integrity protection key, to generate the second PDCP PDU.

Step 703c: The PDCP layer of the base station delivers the second PDCP PDU to a RLC layer of the base station.

Step 703d: The RLC layer of the base station sends the second PDCP PDU to the UE.

It can be understood that because the PDCP layer of the base station is configured to resume integrity protection and encryption by using the first encryption key and the first integrity protection key, the PDCP layer of the base station may perform the encryption operation and the integrity protection operation on the RRC reestablishment message by using the first encryption key and the first integrity protection key, to generate the second PDCP PDU, and deliver the second PDCP PDU to the RLC layer of the base station for being sent to the UE.

In some embodiments of this application, the foregoing step 703 may be specifically implemented by the following step 703e.

Step 703e: The base station sends the second PDCP PDU to the UE after the first signaling is sent, or after the first signaling is successfully sent, or after the base station receives a reception acknowledgement message of the first signaling.

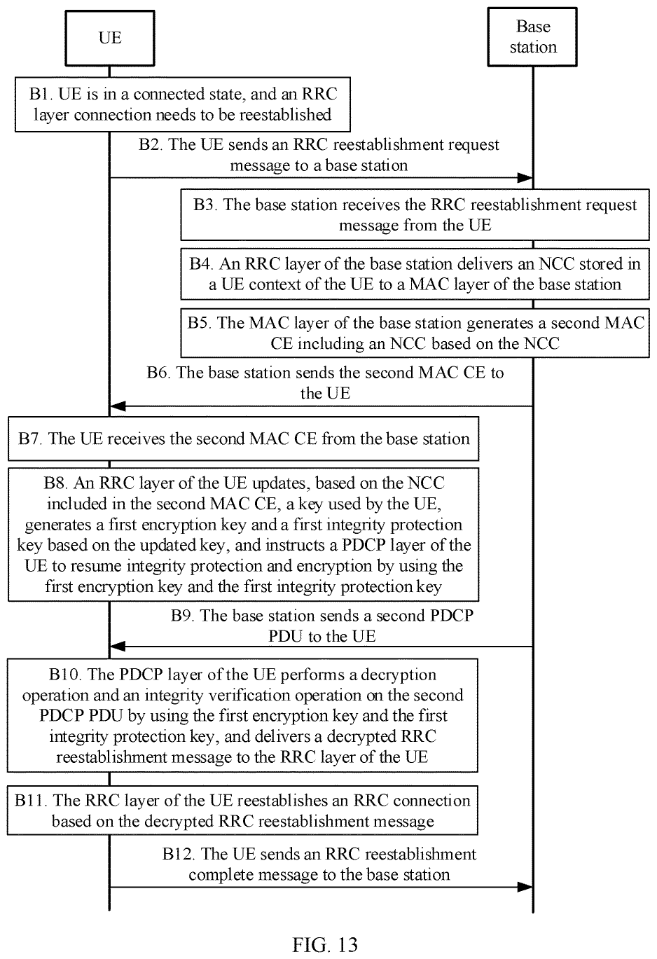

In some embodiments of this application, as shown in FIG. 13, the communication method provided in this embodiment of this application may include the following step B1 to step B12.
B1. UE is in a connected state, and an RRC layer connection needs to be reestablished.
B2. The UE sends an RRC reestablishment request message to a base station.
B3. The base station receives the RRC reestablishment request message from the UE.
B4. An RRC layer of the base station delivers an NCC stored in a UE context of the UE to a MAC layer of the base station.
B5. The MAC layer of the base station generates a second MAC CE including an NCC based on the NCC.
B6. The base station sends the second MAC CE to the UE.
B7. The UE receives the second MAC CE from the base station.
B8. An RRC layer of the UE updates, based on the NCC included in the second MAC CE, a key used by the UE, generates a first encryption key and a first integrity protection key based on the updated key, and instructs a PDCP layer of the UE to resume integrity protection and encryption by using the first encryption key and the first integrity protection key.
B9. The base station sends a second PDCP PDU to the UE.
B10. The PDCP layer of the UE performs a decryption operation and an integrity verification operation on the second PDCP PDU by using the first encryption key and the first integrity protection key, and delivers a decrypted RRC reestablishment message to the RRC layer of the UE.
B11. The RRC layer of the UE reestablishes an RRC connection based on the decrypted RRC reestablishment message.
B12. The UE sends an RRC reestablishment complete message to the base station.

It should be noted that for related descriptions in the foregoing step B1 to step B12, refer to the descriptions in the foregoing embodiment. Details are not described herein again.

It should be noted that, “The RRC layer of the base station generates the RRC reestablishment message, and delivers the RRC reestablishment message to the PDCP layer of the base station, and the PDCP layer of the base station performs an encryption operation and an integrity protection operation on the RRC reestablishment message by using the first encryption key and the first integrity protection key, to generate the second PDCP PDU, and delivers the second PDCP PDU to an RLC layer of the base station” and “the base station generates the second MAC CE” in the foregoing steps may be simultaneously performed. However, the base station needs to first send the second MAC CE to the UE, and then sends the second PDCP PDU to the UE. Alternatively, the base station may add a subPDU corresponding to the second MAC CE and a subPDU corresponding to the second PDCP PDU one MAC PDU and send the MAC PDU to the UE, with the subPDU corresponding to the second MAC CE placed first. In summary, the UE needs to first process the second MAC CE, and the PDCP layer of the UE can process the second PDCP PDU only after the PDCP layer of the UE resumes integrity protection and encryption by using the first encryption key and the first integrity protection key.

It should be noted that before the PDCP layer of the UE resumes integrity protection and encryption by using the first encryption key and the first integrity protection key, if a PDCP entity corresponding to an SRB1 of the UE receives a PDCP PDU, for example, the second PDCP PDU is received first because of retransmission of the second MAC CE, the PDCP entity corresponding to the SRB1 of the UE first does not process the second PDCP PDU until the second MAC CE is received, and the PDCP layer of the UE can process the second PDCP PDU only after the PDCP layer of the UE resumes integrity protection and encryption by using the first encryption key and the first integrity protection key.

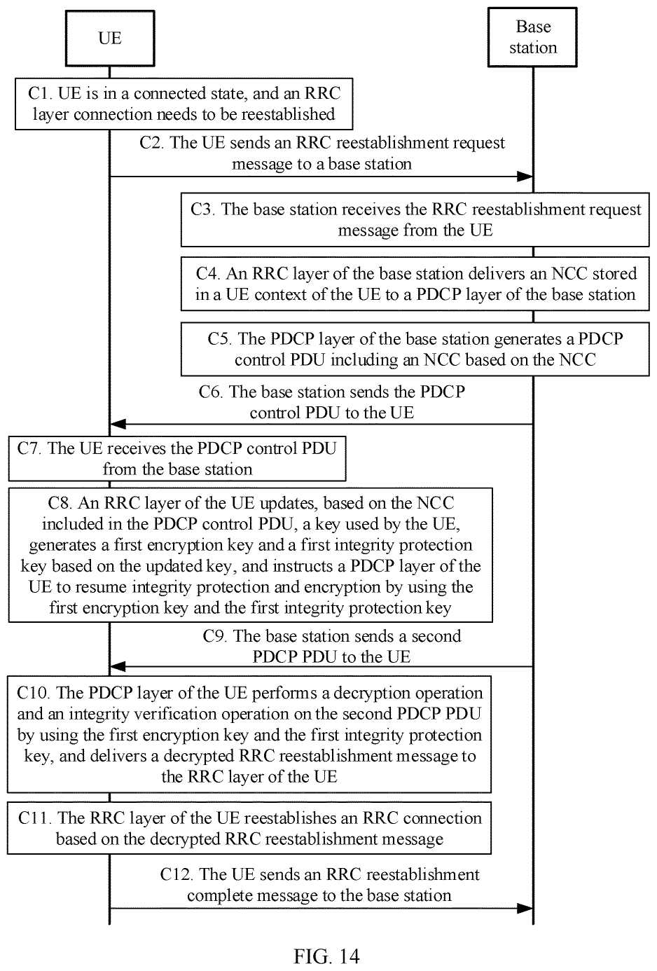

In some embodiments of this application, as shown in FIG. 14, the communication method provided in this embodiment of this application may include the following steps C1 to C12.
C1. UE is in a connected state, and an RRC layer connection needs to be reestablished.
C2. The UE sends an RRC reestablishment request message to a base station.
C3. The base station receives the RRC reestablishment request message from the UE.
C4. An RRC layer of the base station delivers an NCC stored in a UE context of the UE to a PDCP layer of the base station.
C5. The PDCP layer of the base station generates a PDCP control PDU including a NCC based on the NCC.
C6. The base station sends the PDCP control PDU to the UE.
C7. The UE receives the PDCP control PDU from the base station.
C8. An RRC layer of the UE updates, based on the NCC included in the PDCP control PDU, a key used by the UE, generates a first encryption key and a first integrity protection key based on the updated key, and instructs a PDCP layer of the UE to resume integrity protection and encryption by using the first encryption key and the first integrity protection key.
C9. The base station sends a second PDCP PDU to the UE.
C10. The PDCP layer of the UE performs a decryption operation and an integrity verification operation on the second PDCP PDU by using the first encryption key and the first integrity protection key, and delivers a decrypted RRC reestablishment message to the RRC layer of the UE.
C11. The RRC layer of the UE reestablishes an RRC connection based on the decrypted RRC reestablishment message.
C12. The UE sends an RRC reestablishment complete message to the base station.

It should be noted that for related descriptions in the foregoing step C1 to step C12, refer to the descriptions in the foregoing embodiment. Details are not described herein again.

The foregoing method embodiments or the implementations in the method embodiments may be separately executed, or any two or more thereof may be executed together. This may be specifically determined according to an actual use requirement, and is not limited in the embodiments of this application.

The communication method provided in the embodiments of this application may be executed by a communication apparatus. In the embodiments of this application, an example in which the communication apparatus executes the communication method is used to describe the communication apparatus provided in the embodiments of this application.

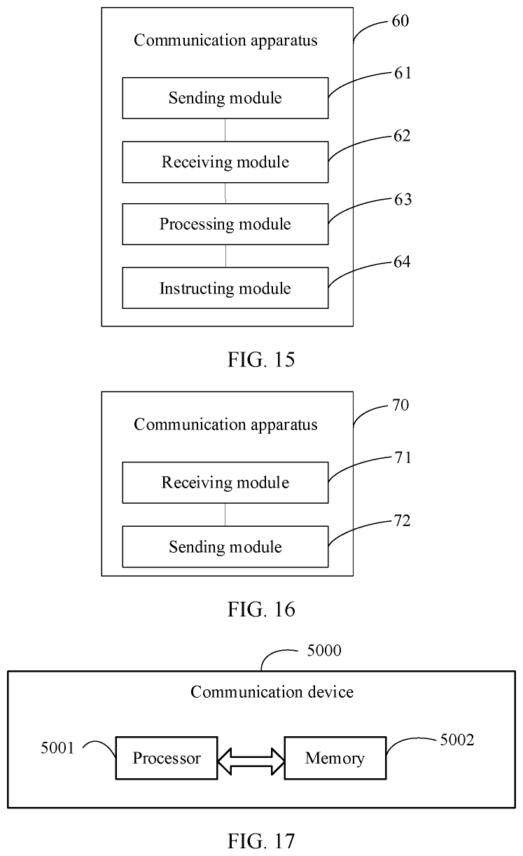

FIG. 15 is a schematic structural diagram of a communication apparatus according to an embodiment of this application, and the apparatus is applied to UE. As shown in FIG. 15, the communication apparatus 60 may include a sending module 61, a receiving module 62, a processing module 63, and an instructing module 64.

The sending module 61 is configured to send an RRC reestablishment request message to a base station.

The receiving module 62 is configured to receive first signaling from the base station, where the first signaling is used to request the UE to update a key used by the UE, the first signaling includes an NCC, and the first signaling is a second MAC CE or a PDCP control PDU.

The processing module 63 is configured to: update, based on the NCC, the key used by the UE, and generate a first encryption key and a first integrity protection key based on the updated key.

The instructing module 64 is configured to instruct a PDCP layer of the UE to resume integrity protection and encryption by using the first encryption key and the first integrity protection key that are generated by the processing module 63.

The processing module 63 is further configured to: after the PDCP layer of the UE resumes integrity protection and encryption by using the first encryption key and the first integrity protection key, process a second PDCP PDU from the base station, where the second PDCP PDU includes an RRC reestablishment message on which integrity protection and encryption have been performed, and the RRC reestablishment message is used to instruct the UE to reestablish an RRC connection.

This embodiment of this application provides a communication apparatus. After sending an RRC reestablishment request message to a base station, UE may receive first signaling that is from the base station and that is used to request the UE to update a key used by the UE. Therefore, an RRC layer of the UE may update, based on the NCC included in the first signaling, the key used by the UE, generate a first encryption key and a first integrity protection key based on the updated key, and instruct a PDCP layer of the UE to resume integrity protection and encryption by using the first encryption key and the first integrity protection key. Then, the PDCP layer of the UE may process a second PDCP PDU from the base station after resuming integrity protection and encryption by using the first encryption key and the first integrity protection key, where the second PDCP PDU includes an RRC reestablishment message on which integrity protection and encryption have been performed, and the RRC reestablishment message is used to instruct the UE to reestablish an RRC connection. In other words, the PDCP layer of the UE first resumes integrity protection and encryption and then processes the second PDCP PDU from the base station. Therefore, integrity protection and encryption may be implemented on the RRC reestablishment message, thereby improving security of the RRC reestablishment message.

In some implementations, the first signaling includes third information, and the third information is a MAC-I generated by performing an integrity protection operation on the NCC; and the instructing module 64 is specifically configured to: request the PDCP layer of the UE to perform an integrity verification operation on the NCC by using the first integrity protection key and the third information; perform the integrity verification operation on the NCC by using the first integrity protection key and the third information; and in a case that the PDCP layer of the UE successfully performs the integrity verification operation on the NCC, instruct the PDCP layer of the UE to resume integrity protection and encryption by using the first encryption key and the first integrity protection key.

In some implementations, the processing module 63 is further configured to enter an idle state in a case that the PDCP layer of the UE fails to perform the integrity verification operation on the NCC.

In some implementations, a parameter used by the PDCP layer of the UE to perform the integrity verification operation on the NCC is a second parameter or a second parameter set; and the second parameter or the second parameter set includes at least one of the following: all bits of a COUNT value are 1, all bits of a BEARER value are 1, and DIRECTION is a downlink direction.

In some implementations, in a case that the first signaling is a second MAC CE, the receiving module 62 is specifically configured to: receive the second MAC CE from the base station; and parse the second MAC CE to obtain the NCC, and deliver the NCC to the RRC layer of the UE.

In some implementations, in a case that the first signaling is a PDCP control PDU, the receiving module 62 is specifically configured to: receive the PDCP control PDU from the base station; and parse the PDCP control PDU to obtain the NCC, and deliver the NCC to the RRC layer of the UE.

In some implementations, the processing module 63 is specifically configured to: perform a decryption operation and an integrity verification operation on the second PDCP PDU by using the first encryption key and the first integrity protection key, and deliver a decrypted RRC reestablishment message to the RRC layer of the UE.

In some implementations, the processing module 63 is further configured to reestablish the RRC connection based on the decrypted RRC reestablishment message. The sending module 61 is further configured to send an RRC reestablishment complete message to the base station, where the RRC reestablishment complete message is a message processed by the PDCP layer of the UE by using the first encryption key and the first integrity protection key.

The communication apparatus provided in this embodiment of this application can implement the processes implemented by the UE in the foregoing method embodiment, and achieve a same technical effect. To avoid repetition, details are not described herein again.

FIG. 16 is another schematic structural diagram of a communication apparatus according to an embodiment of this application, applied to a base station. As shown in FIG. 16, the communication apparatus 70 may include a receiving module 71 and a sending module 72.

The receiving module 71 is configured to receive an RRC reestablishment request message from UE.

The sending module 72 is configured to: send first signaling to the UE, where the first signaling is used to request the UE to update a key used by the UE, the first signaling includes an NCC, and the first signaling is a second MAC CE or a PDCP control PDU; and send a second PDCP PDU to the UE, where the second PDCP PDU includes an RRC reestablishment message on which integrity protection and encryption have been performed, and the RRC reestablishment message is used to instruct the UE to reestablish an RRC connection.

This embodiment of this application provides a communication apparatus. After receiving an RRC reestablishment request message sent by UE, a base station may send, to the UE, first signaling that is used to request the UE to update a key used by the UE, where the first signaling includes an NCC; and send, to the UE, a second PDCP PDU that is used to instruct the UE to reestablish an RRC connection, where the second PDCP PDU includes an RRC reestablishment message on which integrity protection and encryption have been performed. Therefore, the NCC and the RRC reestablishment message are separate, thereby improving security of the RRC reestablishment message.

In some implementations, the communication apparatus provided in this embodiment of this application further includes a processing module and an instructing module. The processing module is configured to: before the sending module 72 sends the second PDCP PDU to the UE, update a key used by the base station, and generate a first encryption key and a first integrity protection key based on the updated key. The instructing module is configured to instruct a PDCP layer of the base station to resume integrity protection and encryption by using the first encryption key and the first integrity protection key that are generated by the processing module.

In some implementations, the communication apparatus provided in this embodiment of this application further includes a delivering module and a generation module. The delivering module is configured to deliver an NCC stored in a UE context of the UE to a MAC layer of the base station. The generation module is configured to generate the second MAC CE based on the NCC delivered by the delivering module, where the second MAC CE is used to request the UE to update the key used by the UE, and the second MAC CE includes the NCC. The sending module 72 is specifically configured to send the second MAC CE generated by the generation module to the UE

In some implementations, the delivering module is specifically configured to: request a PDCP layer of the base station to perform an integrity protection operation on the NCC by using the first integrity protection key; perform the integrity protection operation on the NCC by using the first integrity protection key, to generate a fourth MAC-I, and deliver the fourth MAC-I to the RRC layer of the base station; and deliver the NCC and the fourth MAC-I to the MAC layer of the base station, where the second MAC CE includes the NCC and the fourth MAC-I.

In some implementations, the generation module is specifically configured to: request a PDCP layer of the base station to perform an integrity protection operation on the NCC by using the first integrity protection key; perform the integrity protection operation on the NCC by using the first integrity protection key, to generate a fifth MAC-I, and deliver the fifth MAC-I to the MAC layer of the base station; and generate the second MAC CE based on the NCC and the fifth MAC-I, where the second MAC CE includes the NCC and the fifth MAC-I.

In some implementations, the communication apparatus provided in this embodiment of this application further includes a delivering module and a generation module. The delivering module is configured to deliver an NCC stored in a UE context of the UE to a PDCP layer of the base station. The generation module is configured to generate a PDCP control PDU based on the NCC delivered by the delivering module, where the PDCP control PDU is used to request the UE to update the key used by the UE, and the PDCP control PDU includes the NCC. The sending module 72 is specifically configured to send the PDCP control PDU generated by the generation module to the UE.

In some implementations, the generation module is specifically configured to: perform an integrity protection operation on the NCC by using the first integrity protection key, to generate a sixth MAC-I; and generate the PDCP control PDU based on the NCC and the sixth MAC-I, where the PDCP control PDU includes the sixth MAC-I.

In some implementations, a parameter used by the PDCP layer of the base station to perform the integrity protection operation on the NCC is a second parameter or a second parameter set; and the second parameter or the second parameter set includes at least one of the following: all bits of a COUNT value are 1, all bits of a BEARER value are 1, and DIRECTION is a downlink direction.

In some implementations, the sending module 72 is specifically configured to: generate the RRC reestablishment message, and deliver the RRC reestablishment message to the PDCP layer of the base station; perform an encryption operation and an integrity protection operation on the RRC reestablishment message by using the first encryption key and the first integrity protection key, to generate the second PDCP PDU; deliver the second PDCP PDU to a radio link control RLC layer of the base station; and send the second PDCP PDU to the UE.

In some implementations, the sending module 72 is specifically configured to send the second PDCP PDU to the UE after the first signaling is sent, or after the first signaling is successfully sent, or after the base station receives a reception acknowledgement message of the first signaling.

The communication apparatus provided in this embodiment of this application can implement the processes implemented by the base station in the foregoing method embodiment, and achieve a same technical effect. To avoid repetition, details are not described herein again.

In some implementations, as shown in FIG. 17, an embodiment of this application further provides a communication device 5000, including a processor 5001 and a memory 5002. The memory 5002 stores a program or an instruction that can be run on the processor 5001. For example, when the communication device 5000 is UE, the program or the instruction is executed by the processor 5001 to implement the steps of the foregoing method embodiment on the UE side, and a same technical effect can be achieved. When the communication device 5000 is a base station, the program or the instruction is executed by the processor 5001 to implement the processes of the foregoing method embodiment of the base station, and a same technical effect can be achieved. To avoid repetition, details are not described herein again.

An embodiment of this application further provides UE, including a processor and a communication interface. The communication interface is coupled to the processor, and the processor is configured to run a program or an instruction to implement the steps of the foregoing method embodiment. This UE embodiment corresponds to the foregoing method embodiment on the UE side. Each implementation process and implementation of the foregoing method embodiment may be applicable to this UE embodiment, and a same technical effect can be achieved.

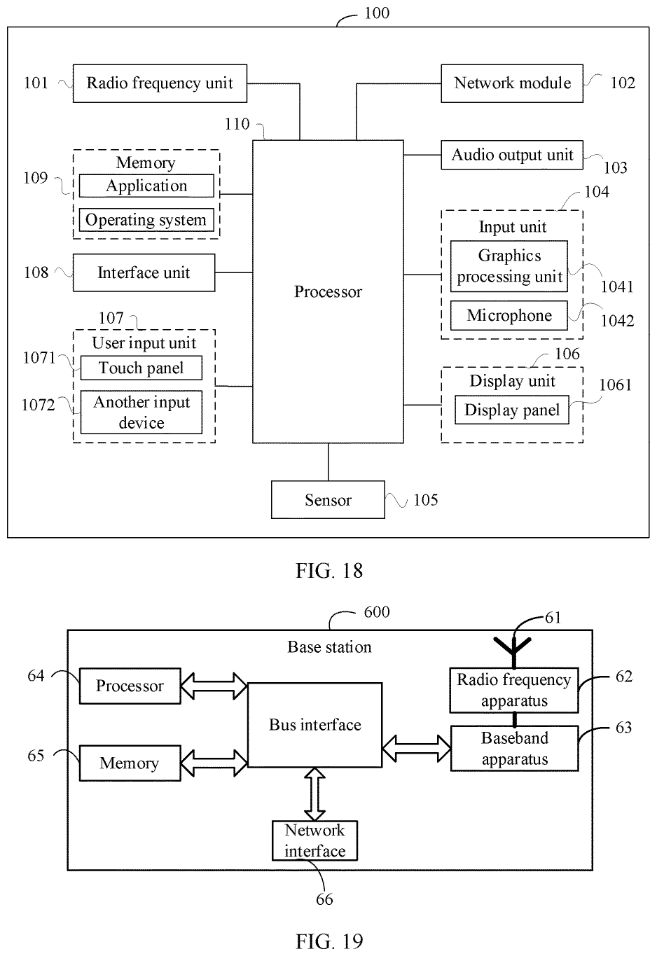

In some implementations, FIG. 18 is a schematic structural diagram of hardware of UE according to an embodiment of this application.

The UE 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the UE 100 may further include the power supply (for example, a battery) that supplies power to each component. The power supply may be logically connected to the processor 110 by using a power supply management system, so as to manage functions such as charging, discharging, and power consumption by using the power supply management system. The UE structure shown in FIG. 18 constitutes no limitation on the UE, and the UE may include more or fewer components than those shown in the figure, or combine some components, or have different component arrangements. Details are not described herein.

It should be understood that, in this embodiment of this application, the input unit 104 may include a Graphics Processing Unit (GPU) 1041 and a microphone 1042, and the graphics processing unit 1041 processes image data of a still image or a video that is obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Usually, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The nonvolatile memory may be a Read-Only Memory (ROM), a Programmable ROM (PROM), an Erasable PROM (EPROM), an Electrically Erasable PROM (EEPROM), or a Flash Memory; whereas the volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a SynchLink DRAM (SLDRAM), or a Direct Rambus RAM (DRRAM). The memory 109 in this embodiment of this application includes but is not limited to these memories and a memory of any other proper type.

The processor 110 may include one or more processing units. In some implementations, an application processor and a modem processor are integrated into the processor 110. The application processor mainly processes an operating system, a user interface, an application, and the like. The modem processor mainly processes a wireless communication signal, for example, a baseband processor. It can be understood that, alternatively, the modem processor may not be integrated into the processor 110.

The UE provided in this embodiment of this application can implement the processes implemented by the UE in the foregoing method embodiment, and achieve a same technical effect. To avoid repetition, details are not described herein again.

An embodiment of this application further provides a base station, including a processor and a communication interface. The communication interface is coupled to the processor, and the processor is configured to run a program or an instruction to implement the steps of the foregoing method embodiment. This base station embodiment corresponds to the foregoing method embodiment of the base station. Each implementation process and implementation of the foregoing method embodiment may be applicable to this base station embodiment, and a same technical effect can be achieved.

In some implementations, an embodiment of this application further provides a base station. As shown in FIG. 19, the base station 600 includes an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information by using the antenna 61, and sends the received information to the baseband apparatus 63 for processing. In a downlink direction, the baseband apparatus 63 processes information that needs to be sent, and sends processed information to the radio frequency apparatus 62. The radio frequency apparatus 62 processes the received information, and sends processed information by using the antenna 61.

In the foregoing embodiment, the method performed by the base station may be implemented in the baseband apparatus 63. The baseband apparatus 63 includes a baseband processor.

The base station provided in this embodiment of this application can implement the processes implemented by the base station in the foregoing method embodiment, and achieve a same technical effect. To avoid repetition, details are not described herein again.

The baseband apparatus 63 may include, for example, at least one baseband board, where a plurality of chips are disposed on the baseband board. As shown in FIG. 19, one chip, for example, the baseband processor, is connected to the memory 65 through a bus interface, to invoke a program in the memory 65 to perform the operations of the network device shown in the foregoing method embodiment.

The base station may further include a network interface 66, and the interface is, for example, a Common Public Radio Interface (CPRI).

In some implementations, the base station 600 in this embodiment of this application further includes an instruction or a program that is stored in the memory 65 and that can be run on the processor 64. The processor 64 invokes the instruction or the program in the memory 65 to perform the method performed by the modules shown in FIG. 19, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing method embodiment, and a same technical effect can be achieved. To avoid repetition, details are not described herein again.

The processor is a processor in the communication device in the foregoing embodiment. The readable storage medium includes a computer readable storage medium, such as a computer ROM, a RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing method embodiment, and a same technical effect can be achieved. To avoid repetition, details are not described herein again.

An embodiment of this application further provides a communication system, including UE and a terminal. The UE may be configured to perform the steps of the foregoing communication method, and the terminal may be configured to perform the steps of the foregoing communication method.

It should be noted that, in this specification, the terms “include,” “comprise,” or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may understand that the method in the foregoing embodiment may be implemented by software in addition to a necessary universal hardware platform or by hardware only. The technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A communication method, performed by User Equipment (UE), comprising:
sending a Radio Resource Control (RRC) reestablishment request message to a base station; and
receiving, by a Medium Access Control (MAC) layer of the UE, a first Medium Access Control Control Element (MAC CE) from the base station, wherein
the first MAC CE comprises a Next hop Chaining Count (NCC) and a first byte stream, the first byte stream comprises an encrypted RRC reestablishment message, and the RRC reestablishment message is used to instruct the UE to reestablish an RRC connection.

2. The method according to claim 1, wherein after the MAC layer of the UE receives the first MAC CE from the base station, the method further comprises:
parsing, by the MAC layer of the UE, the first MAC CE to obtain the NCC and the first byte stream;
delivering, by the MAC layer of the UE, the NCC and the first byte stream to an RRC layer of the UE;
updating, by the RRC layer of the UE based on the NCC, a key used by the UE, and generating a first encryption key and a first integrity protection key based on the updated key;
requesting, by the RRC layer of the UE, a Packet Data Convergence Protocol (PDCP) layer of the UE to process the first byte stream based on the first encryption key and the first integrity protection key; and
processing, by the PDCP layer of the UE, the first byte stream based on the first encryption key and the first integrity protection key.

3. The method according to claim 2, wherein the first byte stream corresponds to a first PDCP Protocol Data Unit (PDU), the first PDCP PDU comprises an encrypted first Message Authentication Code (MAC-I), and the encrypted first MAC-I is generated by a PDCP layer of the base station by performing an integrity protection operation on the RRC reestablishment message; and
the processing, by the PDCP layer of the UE, the first byte stream based on the first encryption key and the first integrity protection key comprises:
parsing, by the PDCP layer of the UE, the first PDCP PDU to obtain the encrypted RRC reestablishment message and the encrypted first MAC-I;
performing, by the PDCP layer of the UE, a decryption operation on the encrypted RRC reestablishment message and the encrypted first MAC-I by using the first encryption key, to obtain a decrypted RRC reestablishment message and a decrypted first MAC-I; and
performing, by the PDCP layer of the UE, an integrity verification operation on the decrypted RRC reestablishment message by using the first integrity protection key and the decrypted first MAC-I.

4. The method according to claim 2, wherein the first MAC CE comprises first information, and the first information is a MAC-I generated by performing an integrity protection operation on the RRC reestablishment message; and
the processing, by the PDCP layer of the UE, the first byte stream based on the first encryption key and the first integrity protection key comprises:
performing, by the PDCP layer of the UE, a decryption operation on the first byte stream by using the first encryption key, to obtain a decrypted RRC reestablishment message; and
performing, by the PDCP layer of the UE, an integrity verification operation on the decrypted RRC reestablishment message by using the first integrity protection key and the first information.

5. The method according to claim 2, wherein the first MAC CE comprises second information, and the second information is a MAC-I generated by performing an integrity protection operation on the NCC and the first byte stream; and
the processing, by the PDCP layer of the UE, the first byte stream based on the first encryption key and the first integrity protection key comprises:
performing, by the PDCP layer of the UE, an integrity verification operation on the NCC and the first byte stream by using the first integrity protection key and the second information; and
when the PDCP layer of the UE successfully performs the integrity verification operation on the NCC and the first byte stream, performing, by the PDCP layer of the UE, a decryption operation on the first byte stream by using the first encryption key, to obtain a decrypted RRC reestablishment message.

6. The method according to claim 3, wherein a parameter used by the PDCP layer of the UE to perform the decryption operation and the integrity verification operation is a first parameter or a first parameter set; and
the first parameter or the first parameter set comprises at least one of the following: a COUNT value is 0, BEARER is a bearer identifier of a Signaling Radio Bearer 1 (SRB 1), or DIRECTION is a downlink direction.

7. The method according to claim 6, further comprising:
setting or incrementing, by the PDCP layer of the UE, a first state variable maintained by a PDCP entity corresponding to the SRB1 to 1 or by 1, wherein the first state variable is a variable corresponding to a COUNT value of a next PDCP Service Data Unit (SDU) expected to be received.

8. The method according to claim 4, wherein a parameter used by the PDCP layer of the UE to perform the decryption operation and the integrity verification operation is a second parameter or a second parameter set; and
the second parameter or the second parameter set comprises at least one of the following: all bits of a COUNT value are 1, all bits of a BEARER value are 1, or DIRECTION is a downlink direction.

9. The method according to claim 3, wherein after the PDCP layer of the UE processes the first byte stream based on the first encryption key and the first integrity protection key, the method further comprises:
entering, by the UE, an idle state when the PDCP layer of the UE fails to perform the integrity verification operation; and
delivering, by the PDCP layer of the UE, the decrypted RRC reestablishment message to the RRC layer of the UE when the PDCP layer of the UE successfully performs the integrity verification operation.

10. The method according to claim 9, wherein after the PDCP layer of the UE delivers the decrypted RRC reestablishment message to the RRC layer of the UE, the method further comprises:
reestablishing, by the RRC layer of the UE, the RRC connection based on the decrypted RRC reestablishment message; and
sending, by the UE, an RRC reestablishment complete message to the base station, wherein the RRC reestablishment complete message is a message processed by the PDCP layer of the UE by using the first encryption key and the first integrity protection key.

11. The method according to claim 10, wherein the reestablishing, by the RRC layer of the UE, the RRC connection based on the decrypted RRC reestablishment message comprises:
when the NCC in the first MAC CE is the same as an NCC in the RRC reestablishment message, reestablishing, by the RRC layer of the UE, the RRC connection based on the decrypted RRC reestablishment message.

12. A communication method, performed by a base station, comprising:
receiving a Radio Resource Control (RRC) reestablishment request message from User Equipment (UE); and
sending, by a Medium Access Control (MAC) layer of the base station, a first Medium Access Control Control Element (MAC CE) to the UE, wherein
the first MAC CE comprises a Next hop Chaining Count (NCC) and a first byte stream, the first byte stream comprises an encrypted RRC reestablishment message, and the RRC reestablishment message is used to instruct the UE to reestablish an RRC connection.

13. The method according to claim 12, wherein after the base station receives the RRC reestablishment request message from the UE, the method further comprises:
updating, by an RRC layer of the base station, a key used by the base station, and generating a first encryption key and a first integrity protection key based on the updated key;
instructing, by the RRC layer of the base station, a Packet Data Convergence Protocol (PDCP) layer of the base station to resume integrity protection and encryption by using the first encryption key and the first integrity protection key; and
generating, by the RRC layer of the base station, the RRC reestablishment message, and requesting the PDCP layer of the base station to apply security protection to the RRC reestablishment message.

14. The method according to claim 13, wherein after the RRC layer of the base station generates the RRC reestablishment message and requests the PDCP layer of the base station to apply security protection to the RRC reestablishment message, the method further comprises:
performing, by the PDCP layer of the base station, security protection on the RRC reestablishment message to generate the first byte stream, and delivering the first byte stream to the RRC layer of the base station, wherein the first byte stream comprises the RRC reestablishment message on which security protection has been performed, and the security protection comprises at least one of the following: an encryption operation or an integrity protection operation;
delivering, by the RRC layer of the base station, the first byte stream and an NCC stored in a UE context of the UE to the MAC layer of the base station; and
generating, by the MAC layer of the base station, the first MAC CE based on the NCC and the first byte stream.

15. The method according to claim 14, wherein the performing, by the PDCP layer of the base station, security protection on the RRC reestablishment message to generate the first byte stream comprises:
performing, by the PDCP layer of the base station, an integrity protection operation on the RRC reestablishment message by using the first integrity protection key, to generate a first Message Authentication Code (MAC-I); and
performing, by the PDCP layer of the base station, an encryption operation on the RRC reestablishment message and the first MAC-I by using the first encryption key, to generate a first PDCP PDU, wherein the first PDCP PDU corresponds to the first byte stream, and the first PDCP PDU comprises the encrypted RRC reestablishment message and the first MAC-I.

16. The method according to claim 14, wherein the performing, by the PDCP layer of the base station, security protection on the RRC reestablishment message to generate the first byte stream, and delivering the first byte stream to the RRC layer of the base station comprises:
performing, by the PDCP layer of the base station, an encryption operation on the RRC reestablishment message by using the first encryption key, to generate the first byte stream;
performing, by the PDCP layer of the base station, an integrity protection operation on the RRC reestablishment message by using the first integrity protection key, to generate first information, wherein the first information is a MAC-I generated by performing the integrity protection operation on the RRC reestablishment message; and
delivering, by the PDCP layer of the base station, the first byte stream and the first information to the RRC layer of the base station, wherein
the first MAC CE generated by the MAC layer of the base station comprises the first byte stream, the NCC, and the first information, and the first information is delivered by the RRC layer of the base station to the MAC layer of the base station.

17. The method according to claim 14, wherein before the RRC layer of the base station delivers the first byte stream and the NCC stored in the UE context of the UE to the MAC layer of the base station, the method further comprises:
requesting, by the RRC layer of the base station, the PDCP layer of the base station to perform an integrity protection operation on the NCC and the first byte stream; and
performing, by the PDCP layer of the base station, the integrity protection operation on the NCC and the first byte stream by using the first integrity protection key, to generate a second MAC-I, and delivering the second MAC-I to the RRC layer of the base station, wherein
the first MAC CE generated by the MAC layer of the base station comprises the first byte stream, the NCC, and the second MAC-I, and the second MAC-I is delivered by the RRC layer of the base station to the MAC layer of the base station.

18. The method according to claim 14, wherein before the MAC layer of the base station generates the first MAC CE based on the NCC and the first byte stream, the method further comprises:
requesting, by the MAC layer of the base station, the PDCP layer of the base station to perform an integrity protection operation on the NCC and the first byte stream; and
performing, by the PDCP layer of the base station, integrity protection on the NCC and the first byte stream by using the first integrity protection key, to generate a third MAC-I, and delivering the third MAC-I to the MAC layer of the base station, wherein
the first MAC CE generated by the MAC layer of the base station comprises the first byte stream, the NCC, and the third MAC-I.

19. The method according to claim 15, wherein a parameter used by the PDCP layer of the base station to perform the encryption operation and the integrity protection operation is a first parameter or a first parameter set; and
the first parameter or the first parameter set comprises at least one of the following: a COUNT value is 0, BEARER is a bearer identifier of a Signaling Radio Bearer (SRB 1), or DIRECTION is a downlink direction.

20. The method according to claim 16, wherein a parameter used by the PDCP layer of the base station to perform the encryption operation and the integrity protection operation is a second parameter or a second parameter set; and
the second parameter or the second parameter set comprises at least one of the following: all bits of a COUNT value are 1, all bits of a BEARER value are 1, or DIRECTION is a downlink direction.
